(19) United States
(12) Patent Application Publication
(10) Pub. No.: US 2013/0168599 A1
(43) Pub. Date: Jul. 4, 2013

(54) PRECURSOR, PROCESS FOR PRODUCTION OF PRECURSOR, PROCESS FOR PRODUCTION OF ACTIVE MATERIAL, AND LITHIUM ION SECONDARY BATTERY

(71) Applicants: Tomohiko Kato, Tokyo (JP); Atsushi Sano, Tokyo (JP); Masaki Sobu, Tokyo (JP); Akinobu Nojima, Tokyo (JP); Yasunaga Kagaya, Tokyo (JP)

(72) Inventors: Tomohiko Kato, Tokyo (JP); Atsushi Sano, Tokyo (JP); Masaki Sobu, Tokyo (JP); Akinobu Nojima, Tokyo (JP); Yasunaga Kagaya, Tokyo (JP)

(73) Assignee: TDK CORPORATION, Tokyo (JP)

(21) Appl. No.: 13/814,593

(22) PCT Filed: Jul. 19, 2011
(86) PCT No.: PCT/JP2011/066295

§ 371 Date: Mar. 5, 2013

(30) Foreign Application Priority Data
Aug. 6, 2010 (JP) 2010-177416
Aug. 6, 2010 (JP) 2010-177424

(51) Int. Cl. H01M 4/1315

(52) U.S. Cl. CPC H01M 4/1315
USPC 252/182.1; 429/223; 429/221

(57) ABSTRACT

Active material is obtained by sintering a precursor, has a layered structure and is represented by the following formula (1). The temperature at which the precursor becomes a layered structure compound in its sintering in atmospheric air is 450° C. or less. Alternatively, the endothermic peak temperature of the precursor when its temperature is increased from 300° C. to 800° C. in its differential thermal analysis in the atmospheric air is 550° C. or less.

Li_{y}NiₐCo_{b}Mn_{c}M_{d}OₓF_{z} (1)

In formula (1), the element M is at least one of Al, Si, Zr, Ti, Fe, Mg, Nb, Ba, and V and 1.9≦(a+b+c+d+y)≦2.1, 1.0≦y≦1.3, 0<a≦0.3, 0≦b≦0.25, 0.3≦c≦0.7, 0≦d≦0.1, 1.9≦(x+z)≦2.0, and 0≦z≦0.15 are satisfied.

### TECHNICAL FIELD

The present invention relates a precursor of an active material, a manufacturing method for a precursor, a manufacturing method for an active material, and a lithium ion secondary battery.

### BACKGROUND ART

In recent years, the spread of various electric vehicles has been anticipated for solving environmental and energy problems. For an on-vehicle power source such as a motor driving power source, which is the key for practical application of such electric vehicles, the development of lithium ion secondary batteries has been extensively conducted. However, for widely spreading the battery as the on-vehicle power source, the battery needs to have higher performance and be less expensive. Moreover, the mileage per charge of an electric vehicle needs to be as long as that of a gasoline-powered vehicle. Thus, the higher energy battery has been desired.

For increasing the energy density of the battery, it is necessary to increase the amount of electricity that can be stored in a positive electrode and a negative electrode per unit mass. As a positive electrode material (active material for a positive electrode) that can meet this demand, a so-called solid-solution positive electrode has been examined. Above all a solid solution including electrochemically inactive layered Li₂MnO₃, and electrochemically active layered LiAO₂ (A represents a transition metal such as Co or Ni) has been expected as a candidate for a high-capacity positive electrode material that can exhibit a high electric capacity of more than 200 mAh/g (see, for example, Patent Document 1).

### PRIOR ART DOCUMENT

### Patent Document

Patent Document 1: JP-A-9-55211

### SUMMARY OF THE INVENTION

### Problems to be Solved by the Invention

The solid-solution positive electrode with Li₂MnO₃ described in Patent Document 1 has high discharge capacity. However, the use of this positive electrode at high charging/discharging potential leads to a problem in that repetition of charging/discharging causes easy deterioration in cycle characteristic. This results in problems that a lithium ion battery including such a solid-solution positive electrode has poor cycle durability under the use with high capacity and that the charging/discharging performed at high potential cause early deterioration.

The present invention has been made in view of the problems of the aforementioned conventional art. It is an object of the present invention to provide a precursor of an active material having high capacity and excellent charging/discharging cycle durability at high potential, a manufacturing method for the precursor, manufacturing method lot the active material, and a lithium ion secondary battery.

### Solutions to the Problems

A precursor according to a first aspect of the present invention made for achieving the above object is a precursor of an active material, and an active material obtained by sintering the precursor has a layered structure and is represented by the following composition formula (1). The temperature at which the precursor becomes layered structure compound in the sintering of the precursor in the atmospheric air is 450° C. or less.

Li_{y}NiₐCo_{b}Mn_{c}M_{d}OₓF_{z} (1)

In the above formula (I), the element M is at least one element selected from the group consisting of Al, Si, Zr, Ti, Fe, Mg, Nb, Ba, and V and 1.9≦(a+b+c+d+y)≦2.1, 1.0≦y≦1.3, 0<a≦0.3, 0≦b≦0.25, 0.3≦c≦0.7, 0≦d≦0.1, 1.9≦(x+z)≦2.0, and 0≦z≦0.15 are satisfied.

A manufacturing method for an active material according to a first aspect of the present invention includes a step of heating the precursor according to the first aspect of the present invention at 500 to 1000° C.

A lithium ion secondary battery according to a first aspect of the present invention has its positive electrode active material layer containing an active material obtained by the manufacturing method for an active material according to the first aspect of the present invention.

In the first aspect of the present invention, the temperature in the sintering process at which the precursor starts to crystallize is 450° C. or less. The lithium ion secondary battery, which includes in the positive electrode active material layer the active material obtained by sintering the precursor that begins to crystallize at low temperature, has high capacity and is difficult to deteriorate in the charging/discharging cycle at high potential.

The specific surface area of the precursor according to the first aspect of the present invention is preferably 0.5 to 6.0 m²/g. Thus, the charging/discharging cycle durability can be easily improved.

A manufacturing method for a precursor according to a first aspect of the present invention includes a step of adjusting the total value of the contents of sugar and sugar acid in a raw-material mixture of a precursor to 0.08 to 2.20 mol % relative to the molar number of an active material obtained from the precursor. This can provide the precursor of the present invention appropriate for the manufacture of the active material having high capacity and excellent charging/discharging cycle durability.

A precursor according to a second aspect of the present invention for achieving the above object is a precursor of an active material, and the active material obtained by sintering the precursor has a layered structure and is represented by the following composition formula (1). In differential thermal analysis of the precursor in the atmospheric an the precursor shows an endothermic peak temperature of 5′50PC or less when the temperature of the precursor is increased from 300° C. to 800° C. is 550° C. or less.

Li_{y}NiₐCo_{b}Mn_{c}M_{d}OₓF_{z} (1)

In the above formula (1), the element M is at least one element selected from the group consisting of Al, Si, Zr, Ti, Fe, Mg, Nb, Ba, and V and 1.9≦(a+b+c+d+y)≦2.1, 1.0≦y≦1.3, 0<a≦0.3, 0≦b≦0.25, 0.3≦c≦0.7, 0≦d≦0.1, 1.9≦(x+z)≦2.0, and 0≦z≦0.15 are satisfied.

A manufacturing method for an active material according to a second aspect of the present invention includes a step of heating the precursor according to the second aspect of the present invention at 500 to 1000° C. lithium ion secondary battery according, to a second aspect of the present invention has its positive electrode active material layer containing an active material obtained by the manufacturing method for the active material according to the second aspect of the present invention.

In the second aspect of the present invention, the upper limit of the endothermic peak temperature of the precursor is 550° C. in the temperature range of 300 to 800° C. The lithium ion secondary battery including in the positive electrode active material layer the active material obtained by sintering the precursor which has such it temperature characteristic has high capacity and is difficult to deteriorate in the charging/discharging cycle at high potential.

The specific surface area of the precursor according to the second aspect of the present invention is preferably 0.5 to 6.0 m²/g. Thus, the charging/discharging cycle durability is easily improved.

### Effects of the Invention

According to the present invention, the precursor of the active material having, high capacity and excellent charging/discharging cycle durability at high potential, the manufacturing method for the precursor, the manufacturing method for the active material, and the lithium ion secondary battery can be provided.

### BRIEF DESCRIPTION OF THE DRAWINGS

FIG. 1 is a schematic cross-sectional view of a lithium ion secondary battery including a positive electrode active material layer containing an active material formed from a precursor according to a preferred embodiment of the present invention.

FIG. 2(a) is a photograph of an active material having a uniform composition formed from a precursor of Example 2 of the present invention, which is taken with a transmission electron microscope (TEM), FIG. 2(h) is an oxygen distribution diagram of a region shown in FIG. 2(a), which is measured by TEM-EDS, FIG. 2(c) is a manganese distribution diagram of the region shown in FIG. 2(a), which is measured by TEM-EDS, FIG. 2(d) is a cobalt distribution diagram of the region shown FIG. 2(a), which is measured by TEM-EDS, and FIG. 4 is a nickel distribution diagram of the region shown in FIG. 2(a), which is measured by TEM-EDS.

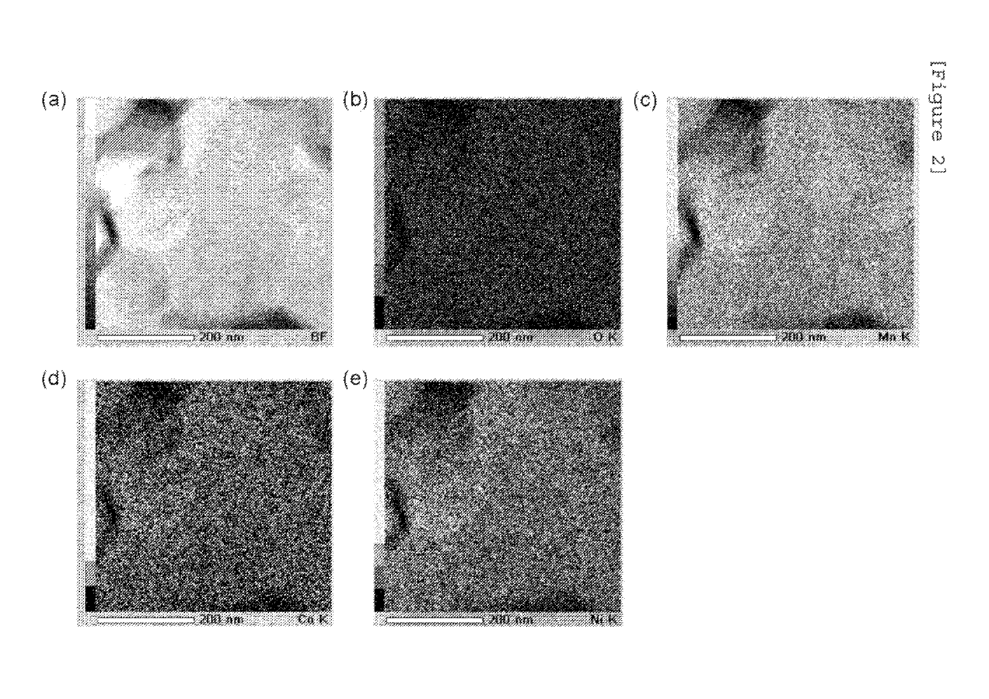

FIG. 3(a) is a photograph of an active material having a non-uniform composition formed from a precursor of Comparative Example 4 of the present invention, which is taken with a TEM, FIG. 3(b) is a carbon distribution diagram of a region shown in FIG. 3(a), which is measured by TEM-EDS. FIG. 3(c) is an oxygen distribution diagram of the region shown in FIG. 3(a), which is measured by TEM-EDS, FIG. 3(d) is a manganese distribution diagram of the region shown in FIG. 3(a), which is measured by TEM-EDS, FIG. 3(e) is a cobalt distribution diagram of the region shown in FIG. 3(a), which is measured by TEM-EDS, and FIG. 3(f) is a nickel distribution diagram of the region shown in FIG. 3(a), which is measured by TEM-EDS.

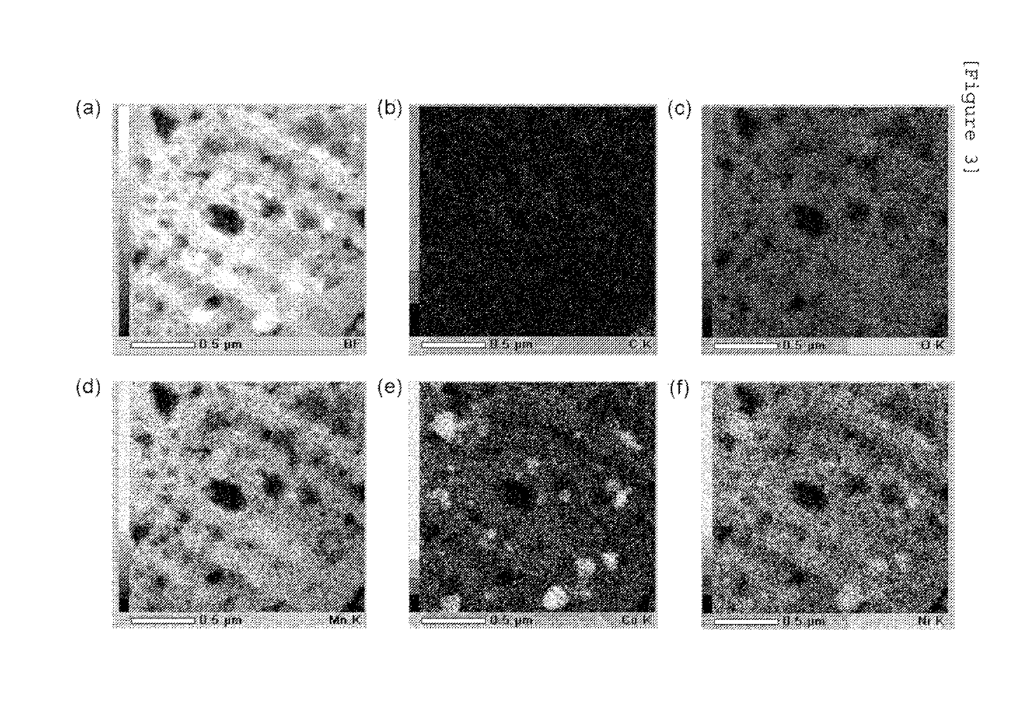

FIG. 4 illustrates an X-ray diffraction pattern at each temperature of the precursor of Example 2 of the present invention.

FIG. 5 illustrates an X-ray diffraction pattern of an active material of Example 2 formed by sintering the precursor of Example 2 of the present invention at 900° C. for 10 hours in the atmospheric air.

FIG. 6 illustrates an X-ray diffraction pattern at each temperature of the precursor of Comparative Example 4.

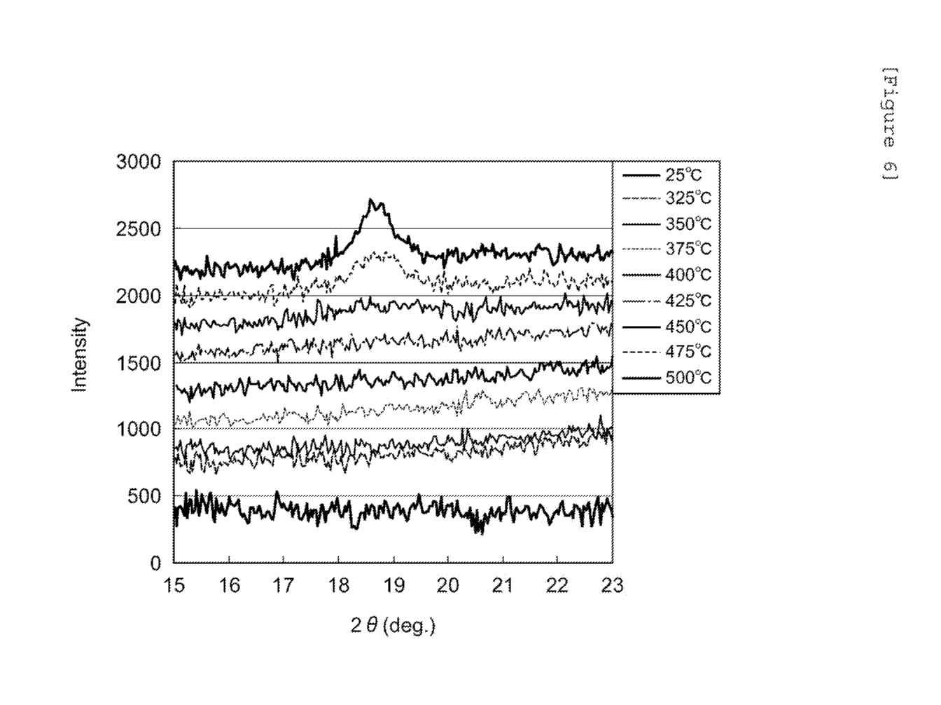

FIG. 7 illustrates the endothermic peak of a precursor of Example 102.

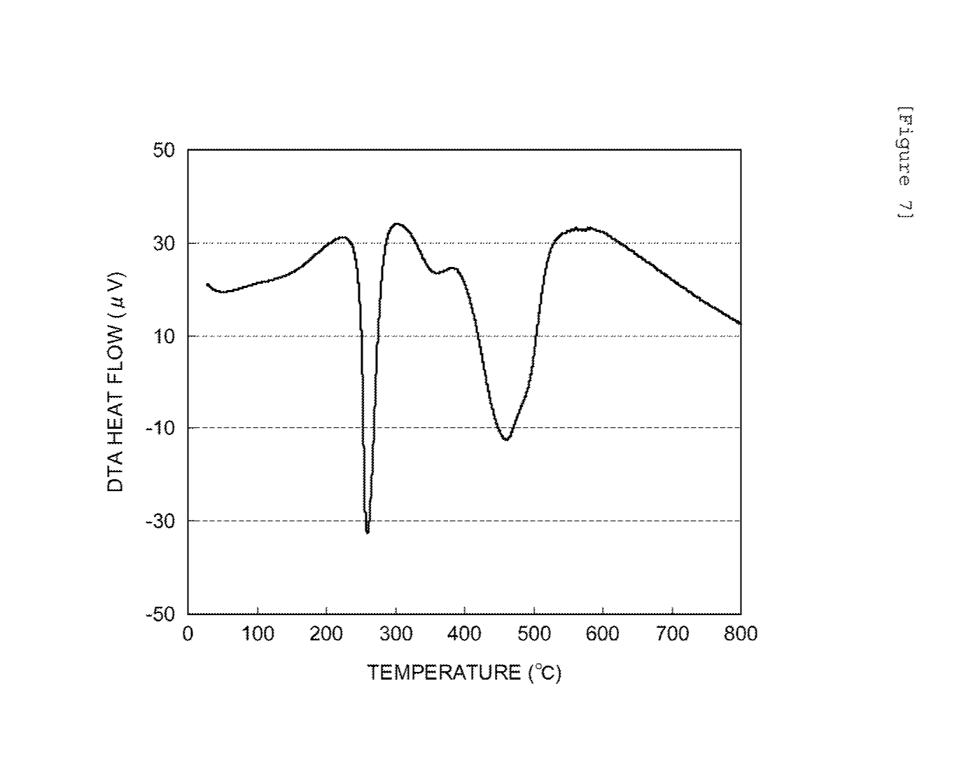

FIG. 8 illustrates the endothermic peak of a precursor of Comparative Example 103.

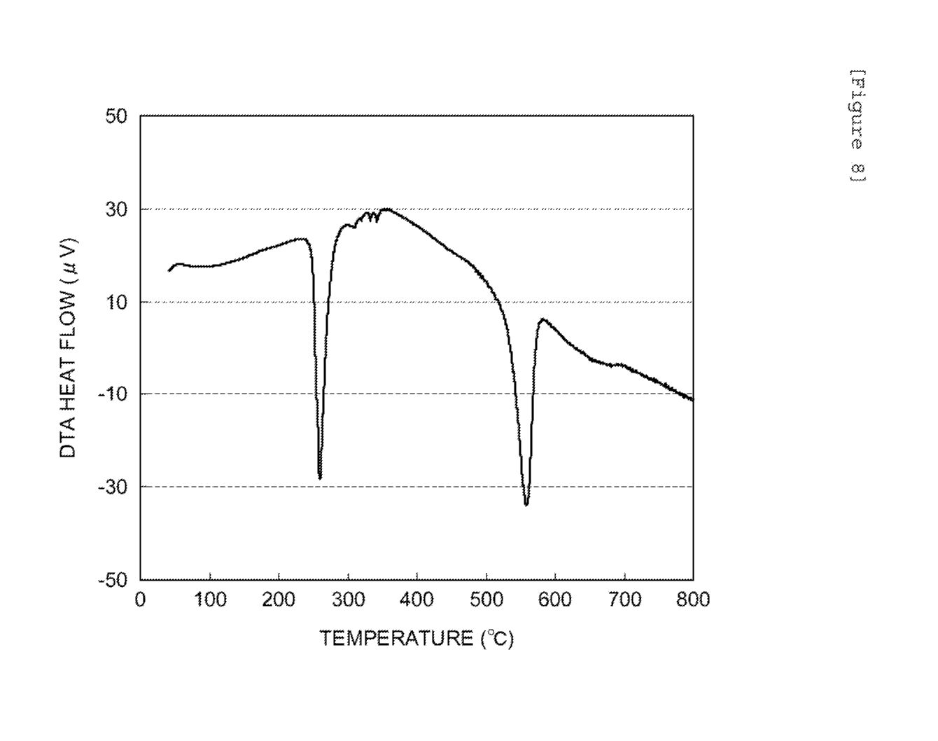

### DESCRIPTION OF EMBODIMENTS

An active material, a precursor of an active material, manufacturing methods for the precursor and the active material, and a lithium ion secondary battery according to preferred embodiments of the present invention are hereinafter described. Note that the present invention is not limited to the embodiments described below.

### First Embodiment

A first embodiment of the present invention is described below.

### (Active Material)

An active material of this embodiment is a lithium-containing composite oxide having a layered structure and is represented by the following composition formula (I):

Li_{y}Ni_{z}Co_{b}Mn_{c}M_{d}OₓF_{z} (1)

wherein the element M is at least one element selected from the group consisting of Al, Si, Zr, Ti, Fe, Mg, Nb, Ba, and V and 1.9≦(a+b+c+d+y)≦2.1, 1.0≦y≦1.3, 0<a≦0.3, 0≦b≦0.25, 0.3≦c≦0.7, 0≦d≦0.1, 1.9≦(x+z)≦2.0, and 0≦z≦0.15 are satisfied.

The layered structure described herein is generally represented by LiAG, (A represents a transition metal such as Co, Ni, or Mn). In this layered structure, a lithium layer, a transition metal layer, and an oxygen layer are stacked in a uniaxial direction. A typical material thereof is a material of α-NaFea, type, such as LiCoO₂ and LiNiO₂. These are rhombohedral-system materials, and belong to a space group R(-3)ₘ from their symmetry. LiMnO₂ is an orthorhombic-system material, and belongs to a space group Pm2m from its symmetry. Li₂MnO₃ can also be represented by Li[Li_{1/3}Mn_{2/3}]O₂, and belongs to a space group C2/in of a monoclinic system. Li₂MnO₃ is a layered compound in which a Li layer, a [Li_{1/3}Mn_{2/3}] layer, and an oxygen layer are stacked. The active material according to this embodiment is a solid solution of a lithium transition metal composite oxide, which is represented by LiAO₂. The metal element occupying the transition metal site may be Li. The “solid solution” is discriminated from a mixture of compounds. For example, a mixture such as a powder of LiNi_{0.5}Mn_{0.5}O₂ or a powder of LiNi_{0.33}Co_{0.33}Mn_{0.34}O₂ is not included in the “solid solution” although such a mixture apparently satisfies the composition formula (1), In the case of performing X-ray diffraction measurement on a simple mixture, different peak positions corresponding to each lattice constant are observed. Therefore, one peak is split into two or three peaks. Meanwhile, in the “solid solution”, one peak is not split. Accordingly, the “solid solution” and the mixture can be discriminated from each other based on the presence or absence of the split of the peak in the X-ray diffraction measurement. The following description is made of the case where the active material has a space group R(-3)m structure of a rhombohedral system.

### (Precursor)

A precursor according to this embodiment is a precursor of the active material of this embodiment. In other words, the active material of this embodiment can be Obtained by sintering the precursor of this embodiment. The precursor of this embodiment includes, for example, Li, Ni, Co, Mn, M, O, and F. In a manner similar to the above composition formula (1), this precursor is a mixture whose molar ratio among Li, Ni, Co, Mn, M, O, and F is y a:b:c:d:x:z. A mixture as a specific example of the precursor is obtained by mixing compounds of Li, Ni, Co, Mn, and M (for example, salts), a compound containing O, and a compound containing F so as to satisfy the above molar ratio, and heating the mixture as necessary. The present inventors consider that satisfying the above molar ratio allows the precursor to start to crystallize at a low temperature of 450° C. or less. Moreover, the present inventors consider that by having an appropriate mixture state, the precursor can easily crystallize at a low temperature of 450° C. or less. One of the compounds included in the precursor may be formed of a plurality of elements selected from the group consisting of Li, Ni, Co, Mn, M, O, and F. Note that the molar ratio between O and F in the precursor is changed depending on the sintering conditions of the precursor (for example, the atmosphere and temperature). Accordingly, the molar ratio between O and F in the precursor may be out of the numeral value range of the above x and z.

It is not entirely clear why the lithium-containing composite oxide obtained from the precursor according to this embodiment has high capacity and has excellent charging/discharging cycle durability at high potential. However, the present inventors' opinion is as follows. Note that the operation effect of the precursor of the present invention is not limited to the description below.

The present inventors have found that the characteristics of a battery (discharge capacity and cycle characteristic) are improved by use of a sintered body obtained by sintering a precursor crystallized at a low temperature of 450° C. as a positive electrode active material. In other words, the temperature (crystallization temperature) at which the precursor according to this embodiment turns into a layered structure compound when the precursor is heated in the atmospheric air is 450° C. or less. The crystallization temperature described herein refers to the temperature at which a peak of (003)-plane of the space group R(-3) in structure of a rhombohedral system is confirmed at a portion of the pattern of the X-ray diffraction intensity of the precursor measured while the precursor is heated in the atmospheric air corresponding to the diffraction angle 2θ in the vicinity of 18 to 19°. The phrase “the peak is confirmed” means that a first derivative dI/dt has a negative value where I represents the X-ray diffraction intensity and the diffraction angle 2θ is t degrees. The present inventors consider that the crystallization temperature can vary with, for example, the composition, raw material (Li salt or metal salt), specific surface area, and mixture state of the precursor. The precursor was subjected to the X-ray diffraction measurement at each temperature while the temperature of the precursor was increased in the atmospheric an by a step of 5° C. for obtaining the lithium-containing composite oxide with the layered structure represented by the composition formula (1). Through this measurement, the crystallization temperature of the precursor was measured. As a result, the present inventors have confirmed that the lowest crystallization temperature is 395° C. Thus, the lower limit of the temperature at which the precursor becomes the layered structure compound is approximately 395° C.

The specific surface area of the precursor according to this embodiment is preferably 0.5 to 6.0 m²/g. Thus, the precursor is easily crystallized at a low temperature of 450° C. or less. As a result, the charging/discharging cycle durability is easily improved. When the specific surface area of the precursor is smaller than 0.5 m²/g. the particle diameter of the precursor after the sintering (particle diameter of the active material) becomes larger. Hence, the composition distribution of the active material tends to be non-uniform. When the specific surface area of the precursor is larger than 6.0 m²/g, the amount of water absorption of the precursor becomes larger. The sintering step therefore becomes difficult. When the amount of water absorption of the precursor is large, the provision of a dry environment is necessary, which increases the cost for manufacturing the active material. Note that the specific surface area can be measured by a known BET type powder-specific surface area measurement apparatus.

### (Manufacturing Method for Precursor)

The precursor can be obtained by mixing the following compounds so as to satisfy the molar ratio of the composition formula (1). Specifically, the precursor can be manufactured from the compounds below by procedures, such as crushing and mixing, thermal decomposition and mixing, precipitation reaction, or hydrolysis. In a particularly preferable method, a liquid raw material obtained by dissolving in a solvent such as water, a Mn compound, a Ni compound, and a Co compound, and a Li compound is mixed, stirred, and furthermore, heated. By drying this, the precursor haying uniform composition distribution can be easily manufactured.

Li compound: lithium hydroxide monohydrate, lithium carbonate, lithium nitrate, lithium chloride, or the like.

Ni compound: nickel sulfate hexahydrate, nickel nitrate hexahydrate, nickel chloride hexahydrate, or the like.
Co compound: cobalt sulfate heptahydrate, cobalt nitrate hexahydrate, cobalt chloride hexahydrate, or the like.
Mn compound: manganese sulfate pentahydrate, manganese nitrate hexahydrate, manganese chloride tetrahydrate, manganese acetate tetrahydrate, or the like.
M compound: Al source, Si source, Zr source. Ti source, Fe source, Mg source, Nb source, Ba source, or V source (oxide, fluoride, or the like). For example, aluminum nitrate nonahydrate, aluminum fluoride, iron sulfate heptahydrate, silicon dioxide, zirconium nitrate oxide dihydrate, titanium sulfate hydrate, magnesium nitrate hexahydrate, niobium oxide, barium carbonate, vanadium oxide, or the like.

A fluorine source such as lithium fluoride or aluminum fluoride may be added to the raw-material mixture of the precursor as necessary.

The raw-material mixture is adjusted by adding a sugar to a solvent in which the compounds are dissolved. The adjusted raw-material mixture may be further mixed and stirred, and heated. An acid ma be added to the raw-material mixture for adjusting the pH thereof as necessary. Although the kind of sugar is not restricted, the sugar is preferably glucose, fructose, sucrose, or the like in consideration of the accessibility and cost. Alternatively, a sugar acid may be added. Although the kind of sugar acid is not restricted, the sugar acid is preferably ascorbic acid, glucuronic acid, or the like in consideration of the accessibility and cost. The sugar and the sugar acid may be added simultaneously. Further, a synthetic resin soluble in hot water, such as polyvinyl alcohol, may be added.

In this embodiment, the total value (Ms) of the content of the sugar and the sugar acid in the raw-material mixture of the precursor is preferably adjusted to 0.08 to 2.20 mol % relative to the molar number of the active material obtained from the precursor. In other words, the total value of the contents of the sugar and the sugar acid in the precursor is preferably 0.08 to 2.20 mol % relative to the molar number of the active material obtained from the precursor. The sugar added into the raw-material mixture of the precursor becomes a sugar acid by an acid. This sugar acid forms a complex together with metal ions in the raw-material mixture of the precursor. Also in the case where the sugar acid itself is added, the sugar acid forms a complex together with metal ions. By heating and stirring the raw-material mixture to which the sugar or the sugar acid is added, the metal ions are uniformly dispersed in the raw-material mixture. By drying this, the precursor having uniform composition distribution can be easily obtained. When the Ms is smaller than 0.05%, the effect that the precursor has uniform composition distribution tends to be small. When the Ms is larger than 2.20%, it is difficult to obtain the effect corresponding to the amount of the sugar or the sugar acid added. Accordingly, when the Ms is large, the manufacturing cost is simply increased.

### (Manufacturing Method for Active Material)

The precursor manufactured by the above method is heated at approximately 500 to 1000° C. Thus, the active material of this embodiment can be obtained. The sintering temperature of the precursor is preferably 700° C. or more and 980° C. or less. A sintering temperature of the precursor of less than 500° C. is not preferable because the sintering reaction of the precursor does not progress sufficiently and the crystallinity of the active material obtained is low. A sintering temperature of the precursor of more than 1000° C. is not preferable because the amount of evaporated Li from the sintered body (active material) becomes larger. This results in high tendency of generating the active material having a composition lacking lithium.

The sintering atmosphere for the precursor preferably includes oxygen. Specifically, the atmosphere includes, for example, a mixture gas including an inert gas and oxygen, and an atmosphere including oxygen such as air. The sintering time for the precursor is preferably 30 minutes or more, and more preferably 1 hour or more.

The powder of the active material (positive electrode material and negative electrode material) preferably has a mean particle diameter of 100 μm or less. In particular, the mean particle diameter of the powder of the positive electrode active material is preferably 10 μm or less. In a nonaqueous electrolyte battery including such a microscopic positive electrode active material, the high output characteristic is improved.

For obtaining the powder of the active material having desired particle diameter and shape, a crusher or classifier is used. For example, a mortar; a ball mill, a bead mill, a sand mill, a vibration ball mill, a planetary ball mill, a jet mill, a counter jet mill, a swilling air flow type jet mill, or a sieve is used. At the time of crushing, wet crushing with water or an organic solvent such as hexane can be employed. The classifying method is not particularly limited. Depending on the purpose, a sieve, a pneumatic classifier, or the like is used for dry crushing or wet crushing.

### (Lithium Ion Secondary Battery)

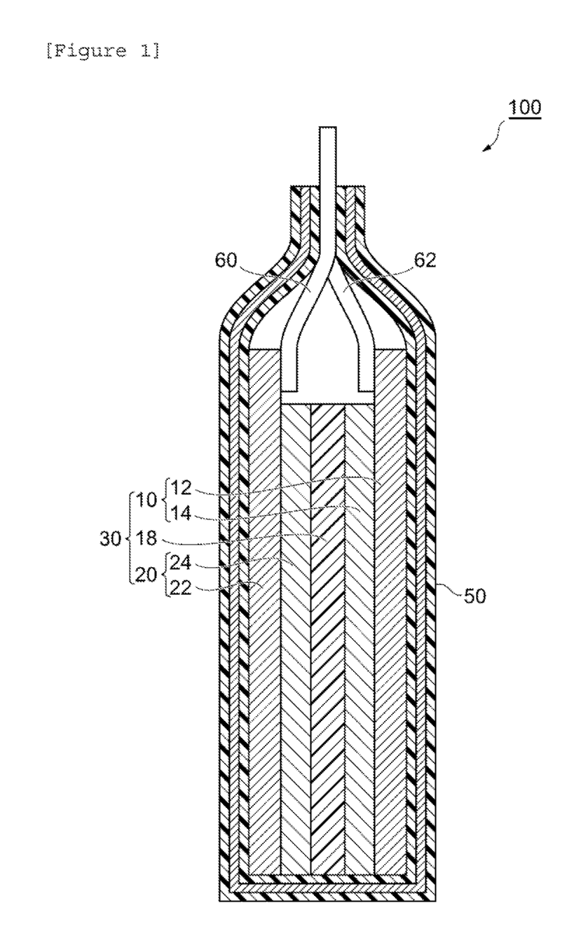

FIG. 1 illustrates a lithium ion secondary battery 100 according to this embodiment. The lithium ion secondary battery 100 includes a power generation element 30, an electrolyte solution containing lithium ions, a case 50, a negative electrode lead 60, and a positive electrode lead 62. The power generation element 30 includes a plate-like positive electrode 10, a plate-like negative electrode 20, and a plate-like separator 18. The negative electrode 20 and the positive electrode 10 face each other. The separator 18 is disposed adjacent to, and between the negative electrode 20 and the positive electrode 10. The case 50 houses the power generation element 30 and the electrolyte solution in a sealed state. One end of the negative electrode lead 60 is electrically connected to the negative electrode 20. The other end of the negative electrode lead 60 protrudes out of the case. One end of the positive electrode lead 62 is electrically connected to the positive electrode 10. The other end of the positive electrode lead 62 protrudes out of the case.

The negative electrode 20 includes a negative electrode current collector 22, and a negative electrode active material layer 24 formed on the negative electrode current collector 22. The positive electrode 10 includes a positive electrode current collector 12, and a positive electrode active material layer 14 formed on the positive electrode current collector 12. The separator 18 is disposed between the negative electrode active material layer 24 and the positive electrode active material layer 14.

The positive electrode active material contained in the positive electrode active material layer 14 has a layered structure and is represented by the composition formula (1). This positive electrode active material is formed by sintering the precursor of this embodiment. As the positive electrode active material contained in the positive electrode active material layer 14, an active material formed by sintering the precursor of this embodiment, in which a material having another crystal structure such as LiMn₂O₄ with a spinel structure or LiFePO₄ with an olivine structure is mixed, may be used.

Any of the negative electrode active materials having modes capable of depositing or storing lithium ions can be selected as the negative electrode active material used for a negative electrode of a nonaqueous electrolyte battery. For example, this material includes the following: a titanium-based material such as lithium titanate having a spinel type crystal structure typified by Li[Li_{1/3}Ti_{5/3}]O₄; an alloy-based material including Si, Sb, Sn, or the like; lithium metal; a lithium alloy (lithium metal-containing alloy such as lithium-silicon, lithium-aluminum, lithium-lead, lithium-aluminum-tin, lithium-gallium, or wood's alloy); a lithium composite oxide (lithium-titanium); and silicon oxide. Further, this material includes an alloy and a carbon material (such as graphite, hard carbon, low-temperature burned carbon, and amorphous carbon) that can store and release lithium.

The positive electrode active material layer 14 and the negative electrode active material layer 24 may contain, in addition to the above main constituent components, a conductive agent, a binder, a thickener, a filler, or the like as a different constituent component.

The material of the conductive agent is not limited as long, as the material is an electronically conductive material that does not adversely affect the battery performance. The conductive material as the conductive agent includes, in general, natural graphite (such as scaly graphite, flaky graphite, or amorphous graphite), artificial graphite, carbon black, acetylene black, Ketjen black, a carbon whisker, a carbon fiber, a metal (such as copper, nickel, aluminum, silver, or gold) powder, a metal fiber, a conductive ceramic material, and the like. Any of these conductive agents may be used alone. Alternatively, a mixture including any of these may be used.

The conductive agent is preferably acetylene black in particular from the viewpoint of the electron conductivity and coatability. The amount of the conductive agent added is preferably 0.1 to 50 wt. %, more preferably 0.5 to 30 wt . . . %, relative to the total weight of the positive electrode active material layer or the negative electrode active material layer. The use of acetylene black crushed into superfine particles of 0.1 to 0.5 μm in size is particularly preferable because the necessary amount of carbon can be reduced. A method of mixing these is physical mixing, ideally, uniform mixing. Therefore, dry or wet mixing using a powder mixer such as a V-type mixer, a S-type mixer, an automated mortar, a ball mill, or a planetary ball mill can be employed.

As the binder, generally, a single material of, or a mixture including two or more of the following can be used: thermoplastic resins such as polytetrafluoroethylene (PTFE), polyvinylidene fluoride (PVDF), polyethylene, and polypropylene; and rubber-elastic polymers such as ethylene-propylene-diene terpolymer (EPDM), sulfonated EPDM, styrene butadiene rubber (SBR), and fluorine rubber. The amount of the binder added is preferably 1 to 50 wt. %, more preferably 2 to 30 wt %, relative to the total weight of the positive electrode active material layer or the negative electrode active material layer.

As the thickener, generally, a single material of, or a mixture including two or more of the following can be used: polysaccharides such as carboxylmethyl cellulose and methyl cellulose. The functional group of the thickener having a functional group which reacts with lithium like the polysaccharide is preferably deactivated by methylation or the like. The amount of the thickener added is preferably 0.5 to 10 wt. %, more preferably 1 to 2 wt. %, relative to the total weight of the positive electrode active material layer or the negative electrode active material layer.

The material of the filler may be any material as long as the battery performance is not adversely affected. As such a material, generally, an olefin-based polymer such as polypropylene or polyethylene, amorphous silica, alumina, zeolite, glass, carbon, or the like is used. The amount of the filler added is preferably 30 wt. % or less relative to the total weight of the positive electrode active material layer or the negative electrode active material layer.

The positive electrode active material layer or the negative electrode active material layer is manufactured suitably as follows. That is, a mixture is obtained by kneading the main constituent component and the other Materials. This mixture is mixed with an organic solvent such as N-methylpyrrolidone or toluene. The resulting mixture solution is heated for approximately 2 hours at approximately 50° C. to 250° C. after the solution is applied or pressed onto the current collector. The method of applying the solution includes, for example, roller coating using an applicator roll or the like, screen coating, a doctor blade method, spin coating, or a method using, a bar coater or the like. The method of applying the solution is not limited to these. The mixture solution is preferably applied to have an arbitrary thickness and an arbitrary shape.

For the current collector of the electrode, iron, copper, stainless steel, nickel, and aluminum can be used. The shape thereof may be a sheet, a foam, a mesh, a porous body, an expandable lattice, or the like. Further, a current collector provided with a hole having an arbitrary shape may be used.

A material generally suggested as the material for use in a lithium battery or the like can be used as a nonaqueous electrolyte. For example, a nonaqueous solvent used as the nonaqueous electrolyte includes: cyclic carbonate esters such as propylene carbonate, ethylene carbonate, butylene carbonate, chloroethylene carbonate, and vinylene carbonate; cyclic esters such as γ-butyrolactone and γ-valerolactone; chain carbonates such as dimethyl carbonate, diethyl carbonate, and ethyl methyl carbonate; chain esters such as methyl formate, methyl acetate, and methyl butyrate; tetrahydrofuran or derivatives thereof; ethers such as 1,3-dioxane, 1,4-dioxane, 1,2-dimethoxyethane, 1,4-dibutoxyethane, and methyl diglyme: nitriles such as acetonitrile and benzonitrile; dioxolane or derivatives thereof; and ethylene sulfide, sulfolane, sultone, or derivatives thereof. Any of these may be used alone, or two or more of these may be used as a mixture. The nonaqueous electrolyte is not limited to these.

Moreover, a combination including an electrolyte solution and a solid electrolyte may be used. As the solid electrolyte, a crystalline or amorphous inorganic solid electrolyte can be used. As the crystalline inorganic solid electrolyte, thio-LISICON may be used. Typical thio-LISICON is LiI, Li₃N, Li₁₊ₓMₓTi₂₋ₓ(PO₄)₃ (M=Al, Sc, Y, or La). Li_{0.5+3x}R_{0.5+x}TiO₃ (R=La, Pr, Nd, or Sm), or Li₄₋ₓGe₁₋ₓPₓS₄. The applicable amorphous inorganic solid electrolyte includes, for example, LiI—Li₂O—B₂O₅, Li₂O—SiO₂, LiI—Li₂S—B₂S₃, LiI—Li₂S—SiS₂, and Li₂S—SiS₂—Li₃PO₄.

For example, the electrolyte salt used for the nonaqueous electrolyte includes: an inorganic ion salt containing one kind of lithium (Li), sodium (Na), and potassium (K), such as LiClO₄, LiBF₄, LiAsF₆, LiPF₆, LiSCN, LiBr, LiI, Li₂SO₄, LiB₁₀Cl₁₀, NaClO₄, NaI, NaSCN, NaBr, KClO₄ or KSCN; and an organic ion salt such as LiCF₃SO₃, LiN(CF₃SO₂)₂, LiN(C₂F₅SO₂)₂, LiN(CF₃SO₂)(C₄F₉SO₂), LiC(CF₁SO₂)₃, LiC(C₂F₅SO₂)₃ (CH₃)₄NBF₄, (CH₃)₄NBr, (C₂H₅)₄NClO₄, (C₂H₅)₄NI, (C₃H₇)₄NBr, (n-C₄H₉)₄NClO₄, (n-C₄H₉)₄NI, (C₂H₅)₄N-maleate, (C₂H₅)₄N-benzoate, (C₂H₅)₄N-phtalate, lithium stearyl sulfonate lithium octyl sulfonate, or lithium dodecyl benzene sulfonate. Any of these ionic compounds can be used alone, or two or more kinds thereof may be used as a mixture.

Further, a mixture obtained by mixing LiPF₆ and a lithium salt including a perfluoroalkyl group such as LiN(C₂F₅SO₂)₂ is preferably used. This can decrease the viscosity of the electrolyte further. Therefore, the low-temperature characteristic can be further improved. Moreover, the self-discharge can be suppressed.

As the nonaqueous electrolyte, an ambient temperature molten salt or ionic liquid may be used.

The concentration of the electrolyte salt in the nonaqueous electrolyte is preferably 0.1 mol/l to 5 mol/l, and more preferably 0.5 mol/l to 2.5 mol/l. This can surely provide the nonaqueous electrolyte battery having high battery characteristics.

As the separator for the nonaqueous electrolyte battery, a porous film and a nonwoven fabric exhibiting excellent high-rate discharge performance, and the like are preferably used alone or in combination. The material used for the separator for the nonaqueous electrolyte battery includes, for example, a polyolefin-based resin typified by polyethylene and polypropylene, a polyester-based resin typified by polyethylene terephthalate and polybutylene terephthalate, polyvinylidene fluoride, vinylidene fluoride-hexafluoropropylene copolymer, vinylidene fluoride-perfluorovinylether copolymer, vinylidene fluoride-tetrafluoroethylene copolymer, vinylidene fluoride-trifluoroethylene copolymer, vinylidene fluoride-fluoroethylene copolymer, vinylidene fluoride-hexafluoroacetone copolymer, vinylidene fluoride-ethylene, copolymer, vinylidene fluoride-propylene copolymer, vinylidene fluoride-trifluoropropylene copolymer, vinylidene fluoride-tetrafluoroethylne-hexafluoropropylene copolymer, and vinylidene fluoride-ethylene-tetrafluoroethylene copolymer.

The porosity of the separator for the nonaqueous electrolyte battery is preferably 98 vol. % or less from the viewpoint of the strength. From the viewpoint of the charging/discharging characteristic, the porosity is preferably 20 vol. % or more.

As the separator for the nonaqueous electrolyte battery, for example, a polymer gel including, the electrolyte and a polymer such as acrylonitrile, ethylene oxide, propylene oxide, methyl methacrylate, vinyl acetate, vinyl pyrrolidone, or polyvinylidene fluoride may be used. The use of the gel-form nonaqueous electrolyte can provide an effect of preventing the liquid leakage.

### Second Embodiment

A second embodiment of the present invention is hereinafter described.

### (Active Material)

An active material of this embodiment is a lithium-containing composite oxide having a layered structure and is represented by the following composition formula (I):

Li_{y}NiₐCo_{b}Mn_{c}M_{d}IₓF_{z} (1)

wherein the element M is at least one element selected from the group consisting of Al, Si, Zr, Ti, Fe, Mg, Nb, Ba, and V and 1.9≦(a+b+c+d+y)≦2.1, 1.0≦y≦0<a≦0.3, 0≦b≦0.25, 0.3≦c≦0.7, 0≦d≦0.1, 1.9≦(x+z)≦2.0, and 0≦z≦0.15 are satisfied.

The layered structure described herein is generally represented by LiAO₂ to represents a transition metal such as Co, Ni, or Mn). In this layered structure, a lithium layer, a transition metal layer, and an oxygen layer are stacked in a uniaxial direction. A typical material thereof is a material of α-NaFeO₂ type, such as LiCoO₂ and LiNiO₂. These are rhombohedral-system materials, and belong to a space group R(-3)ₘ from their symmetry. LiMnO₂ is an orthorhombic-system material, and belongs to a space group Pm2m in from its symmetry. Li₂MmO₃ can also be represented by Li[Li_{1/3}Mn]O₂, and belongs to a space group C2/m of a monoclinic system. Li₂MnO₃ is a layered compound in which a Li layer, a [Li_{1/3}Mn_{2/3}] layer, and an oxygen layer are stacked. The active material according to this embodiment is a solid solution of a lithium transition metal composite oxide, which is represented by LiAO₂. The metal element occupying the transition metal site may be Li. The “solid solution” is discriminated from a mixture of compounds. For example, a mixture such as a powder of LiNi_{0.5}Mn_{0.5}O₂ or a powder of LiNi_{0.33}Co_{0.33}Mn_{0.34}O₂ is not included in the “solid solution” although such a mixture apparently satisfies the composition formula (1). In the case of performing X-ray diffraction measurement on a simple mixture, different peak positions corresponding to each lattice constant are observed. Therefore, one peak is split into two or three peaks. Meanwhile, in the “solid solution”, one peak is not split. Accordingly the “solid solution” and the mixture can be discriminated from each other based on the presence or absence of the split of the peak in the X-ray diffraction measurement. The following description is made of the case where the active material has a space group (−3)ₘ structure of a rhombohedral system.

### (Precursor)

A precursor according to this embodiment is a precursor of the active material of this embodiment. In other words, the active material of this embodiment can be obtained by sintering the precursor of this embodiment. The precursor of this embodiment includes, for example, Li, Ni, Co, Mn, M, O, and F. In a manner similar to the above composition formula (1), this precursor is a mixture whose molar ratio among Li, Ni, Co, Mn, M, O, and F is y:a:b:c:d:x:z. A mixture as a specific example of the precursor is obtained by mixing compounds of Li, Ni, Co, Mn, and M (for example, salts), a compound containing O, and a compound containing F so as to satisfy the above molar ratio, and heating the mixture as necessary. One of the compounds included in the precursor may be formed of a plurality of elements selected from the group consisting of Li, Ni, Co, Mn, M, O, and F. Note that the molar ratio between O and F in the precursor is changed depending on the sintering conditions of the precursor (for example, the atmosphere and temperature). Accordingly, the molar ratio between O and F in the precursor lay be out of the numeral value range of the above x and z.

It is not entirely clear why the lithium-containing composite oxide obtained from the precursor according to this embodiment has high capacity and has excellent charging/discharging cycle durability at high potential. However, the present inventors' opinion is as follows. Note that the operation effect of the precursor of the present invention is not limited to the description below.

The present inventors have found that the characteristics of a battery (discharge capacity and charging/discharging cycle characteristic) are improved by use of a sintered body obtained by sintering a precursor exhibiting an endothermic peak of 550° C. or less when the temperature is increased from 300° C. to 800° C. as a positive electrode active material. In other words, according to differential thermal analysis of the precursor of this embodiment in the atmospheric air, the precursor exhibits an endothermic peak at 550° C. or less when the temperature is increased from 300° C. to 800° C. The precursor was subjected to the X-ray diffraction measurement at each temperature while the temperature of the precursor was increased in the atmospheric air by a step of 5° C. for obtaining, the lithium-containing composite oxide with the layered structure represented by the composition formula (1). Through this measurement, the crystallization temperature of the precursor was measured. As a result, the present inventors have confirmed that the lowest crystallization temperature is 395° C. Thus, the lower limit of the temperature at which the precursor becomes the layered structure compound is approximately 395° C.

The differential thermal analysis (DTA) generally refers to a method for measuring the temperature difference between a sample and a reference material as a temperature function while the temperatures of the sample and the reference material are changed according to a certain program. The temperature difference between be sample and the reference material is measured as an electromotive force corresponding, to the temperature difference by a differential thermocouple. In the differential thermal analysis, the temperature difference between the sample and the reference material is increased if a chemical reaction occurs in the sample. Accordingly, the temperature at which the chemical reaction occurs in the sample can be detected as a maximal value (endothermic peak) of the temperature difference between the sample and the reference material.

The temperature rising speed of the precursor in the differential thermal analysis is approximately 10° C./min. The atmosphere for the precursor in the differential thermal analysis is atmospheric air. The standard sample used in the differential thermal analysis is an alumina powder. The temperature range of the precursor in the differential thermal analysis needs to be a temperature range in which the progress of sintering reaction of the precursor is anticipated. Therefore, this temperature range is approximately 300° C. to 800° C. The endothermic peak of the precursor according to this embodiment means an endothermic peak having a magnitude of 5 μV·sec/mg or more.

In this embodiment, it is considered as follows. An endothermic peak temperature of the precursor of 550° C. or less exhibited when the temperature is increased from 300° C. to 800° C. means that the crystallization of the precursor progresses at a low temperature of 550° C. or less. For example, when the precursor includes a hydroxide or a nitrate as a material compound, for example, the dehydration of the hydroxyl group or oxidation reaction of an NO group contained in the precursor progresses even if the temperature of the precursor is 550° C. or less. Accordingly, the generated water, NO₂, and the like are removed from the precursor. It is considered that this progresses the crystallization of the precursor. Note that the present inventors consider that the endothermic peak temperature is different depending on the composition, the kind of material (Li salt, metal salt), and the specific surface area and the mixture state of the precursor. Moreover, the present inventors consider that the endothermic peak temperature of the precursor becomes 550° C. or less only if the precursor has the composition represented by the composition formula (1). Further, the present inventors consider that the endothermic peak temperature of the precursor easily becomes 550° C. or less if the precursor has an appropriate specific surface area and mixture state. When the endothermic peak temperature of the precursor becomes 550° C. or less, the active material having uniform composition distribution and less segregation can be obtained by sintering the precursor. By the use of such an active material, the discharge capacity and the charging/discharging cycle durability of the battery are improved.

When the endothermic peak temperature of the precursor is higher than 550° C., the battery including the active material obtained from such a precursor has lower discharge capacity and its charging/discharging cycle durability is deteriorated.

The specific surface area of the precursor according to the present invention is preferably 0.5 to 6.0 m²/g. Thus, the endothermic peak temperature of the precursor easily becomes 550° C. or less. This results in the easy improvement of the charging/discharging cycle durability. When the specific surface area of the precursor is smaller than 0.5 m²/g, the particle diameter of the precursor after the sintering (particle diameter of the active material) becomes larger. Accordingly, the composition distribution of the active material tends to be non-uniform. When the specific surface area of the precursor is larger than 6.0 m²/g, the amount of water absorption of the precursor becomes larger. Accordingly, the sintering step becomes difficult. When the amount of water absorption of the precursor is large, the provision of a dry environment is necessary, which increases the cost for manufacturing the active material. Note that the specific surface area can be measured by a known BET type powder-specific surface area measurement apparatus.

### (Manufacturing Method for Precursor)

The precursor can be obtained by mixing the following compounds so as to satisfy the molar ratio of the composition formula (1). Specifically, the precursor can be manufactured from the compounds below by a method such as crushing and mixing, thermal decomposition and mixing, precipitation reaction, or hydrolysis. In a particularly preferable method, a liquid raw material obtained by dissolving in a solvent such as water, a Mn compound, a Ni compound, and a Co compound, and a Li compound is mixed, stirred, and furthermore, heated. By drying this, the composite oxide (precursor) having a uniform composition and an endothermic peak temperature of 550° C. or less can be easily manufactured as the precursor.

Li compound: lithium hydroxide monohydrate, lithium carbonate, lithium nitrate, lithium chloride, or the like.

Ni compound: nickel sulfate hexahydrate, nickel nitrate hexahydrate, nickel chloride hexahydrate, or the like.
Co compound: cobalt sulfate heptahydrate, cobalt nitrate hexahydrate, cobalt chloride hexahydrate, or the like.
Mn compound: manganese sulfate pentahydrate, manganese nitrate hexahydrate, manganese chloride tetrahydrate, manganese acetate tetrahydrate, or the like.
M compound: Al source, Si source, Zr source, Ti source, Fe source, Mg source, Nb source, Ba source, or V source (oxide, fluoride, or the like). For example, aluminum nitrate nonahydrate, aluminum fluoride, iron sulfate heptahydrate, silicon dioxide, zirconium nitrate oxide dihydrate, titanium sulfate hydrate, magnesium nitrate hexahydrate, niobium oxide, barium carbonate, vanadium oxide, or the like.

A fluorine source such as lithium fluoride or aluminum fluoride may be added to the raw-material mixture of the precursor as necessary.

The raw-material mixture is adjusted by adding a sugar to a solvent in which the compounds are dissolved. The adjusted raw-material mixture may be further mixed and stirred, and heated. An acid may be added to the raw-material mixture for adjusting the pH as necessary. Although the kind of sugar is not restricted, the sugar is preferably glucose, fructose, sucrose, or the like in consideration of the accessibility and cost. Alternatively, a sugar acid may be added. Although the kind of sugar acid is not restricted, the sugar acid is preferably ascorbic acid, glucuronic acid, or the like in consideration of the accessibility and cost. The sugar and the sugar acid may be added simultaneously. Further, a synthetic resin soluble in hot water, such as polyvinyl alcohol, may be added.

In this embodiment, the total value (Ms) of the content of the sugar and the sugar acid in the raw-material mixture of the precursor is preferably adjusted to 0.08 to 2.20 mol % relative to the molar number of the active material obtained from the precursor. In other words, the total value of the contents of the sugar and the sugar acid in the precursor is preferably 0.08 to 2.20 mol % relative to the molar number of the active material obtained from the precursor. The sugar added into the raw-material mixture of the precursor becomes a sugar acid by an acid. This sugar acid forms a complex together with metal ions in the raw-material mixture of the precursor. Also in the case where the sugar acid itself is added, the sugar acid forms a complex together with metal ions. By heating and stirring the raw-material mixture to which the sugar or the sugar acid is added, the metal ions are uniformly dispersed in the raw-material mixture. By drying this, the precursor having uniform composition distribution can be easily obtained. When the Ms is smaller than 0.05%, the effect that the precursor has uniform composition distribution tends to be small. When the Ms is larger than 2.20%, it is difficult to obtain the effect corresponding to the amount of the sugar or the sugar acid added. Accordingly, when the Ms is large, the manufacturing cost is simply increased.

### (Manufacturing Method for Active Material)

The precursor manufactured by the above method is heated at approximately 500 to 1000° C. Thus, the active material of this embodiment can be obtained. The sintering temperature of the precursor is preferably 700° C. or more and 980° C. or less. A sintering temperature of the precursor of less than 500° C. is not preferable because the sintering reaction of the precursor does not progress sufficiently and the crystallinity of the active material obtained is low. A sintering temperature of the precursor of more than 1000° C. is not preferable because the amount of evaporated Li from the sintered body (active material) becomes larger. This results in high tendency of generating the active material having a composition lacking lithium.

The sintering atmosphere for the precursor preferably includes oxygen. Specifically, the atmosphere includes, for example, a mixture gas including an inert gas and oxygen, and an atmosphere including oxygen such as air. The sintering time for the precursor is preferably 30 minutes or more, and more preferably 1 hour or more.

The powder of the active material (positive electrode material and negative electrode material) preferably has a mean particle diameter of 100 μm or less. In particular, the mean particle diameter of the powder of the positive electrode active material is preferably 10 μm or less. In a nonaqueous electrolyte battery including such a microscopic positive electrode active material, the high output characteristic is improved.

For obtaining the powder of the active material having desired particle diameter and shape, a crusher or classifier is used. For example, a mortar, a ball mill, a bead mill, a sand mill, a vibration ball mill, a planetary ball mill, a jet mill, a counter jet mill, a swirling air flow type jet mill, or a sieve is used. At the time of crushing, wet crushing with water or an organic solvent such as hexane can be employed. The classifying method is not particularly limited. Depending on the purpose, a sieve, a pneumatic classifier, or the like is used for dry crushing or wet crushing.

### (Lithium Ion Secondary Battery)

FIG. 1 illustrates a lithium ion secondary battery 100 according to this embodiment. The lithium ion secondary battery 100 includes a power generation element 30, an electrolyte solution containing lithium ions, a case 50, a negative electrode lead 60, and a positive electrode lead 62. The power generation element 30 includes a plate-like positive electrode 10, a plate-like negative electrode 20, and a plate-like separator 18. The negative electrode 20 and the positive electrode 10 face each other. The separator 18 is disposed adjacent to, and between the negative electrode 20 and the positive electrode 10. The case 50 houses the power generation element 30 and the electrolyte solution in a sealed state. One end of the negative electrode lead 60 is electrically connected to the negative electrode 20. The other end of the negative electrode lead 60 protrudes out of the case. One end of the positive electrode lead 62 is electrically connected to the positive electrode 10. The other end of the positive electrode lead 62 protrudes out of the case.

The negative electrode 20 includes a negative electrode current collector 22, and a negative electrode active material layer 24 formed on the negative electrode current collector 22. The positive electrode 10 includes a positive electrode current collector 12, and a positive electrode active material layer 14 formed on the positive electrode current collector 12. The separator 18 is disposed between the negative electrode active material layer 24 and the positive electrode active material layer 14.

The positive electrode active material contained in the positive electrode active material layer 14 has a layered structure and is represented by the following composition formula (1). This positive electrode active material is formed by sintering the precursor of this embodiment. As the positive electrode active material contained in the positive electrode active material layer 14, an active material formed by sintering the precursor of this embodiment, in which a material having another crystal structure such as LiMn₂O₄ with a spinel structure or LiFePO₄ with an olivine structure is mixed, may be used.

Any of the negative electrode active materials having modes capable of depositing or storing lithium ions can be selected as the negative electrode active material used for a negative electrode of a nonaqueous electrolyte battery. For example, this material includes the following: a titanium-based material such as lithium titanate having a spinel type crystal structure typified by Li[Li_{1/3}Ti_{5/3}]O₄; an alloy-based material including Si, Sb, Sn, or the like; lithium metal; a lithium alloy (lithium metal-containing alloy such as lithium-silicon, lithium-aluminum, lithium-lead, lithium-tin, lithium-aluminum-tin, lithium-gallium, or wood's alloy); a lithium composite oxide (lithium-titanium); and silicon oxide. Further, this material includes an alloy and a carbon material (such as graphite, hard carbon, low-temperature burned carbon, and amorphous carbon) that can store and release lithium.

The positive electrode active material layer 14 and the negative electrode active material layer 24 may contain, in addition to the above main constituent components, a conductive agent, a binder, a thickener, a filler, or the like as a different constituent component.

The material of the conductive agent is not limited as long as the material is an electronically conductive material that does not adversely affect the battery performance. The conductive material as the conductive agent includes, in general, natural graphite (such as scaly graphite, flaky graphite, or amorphous graphite), artificial graphite, carbon black, acetylene black, Ketjen black, a carbon whisker, a carbon fiber, a metal (such as copper, nickel, aluminum, silver, or gold) powder, a metal fiber, a conductive ceramic material, and the like. Any of these conductive agents may be used alone. Alternatively, a mixture including any of these may be used.

The conductive agent is preferably acetylene black in particular from the viewpoint of the electron conductivity and coatability. The amount of the conductive agent added is preferably 0.1 to 50 wt. %, more preferably 0.5 to 30 wt. %, relative to the total weight of the positive electrode active material layer or the negative electrode active material layer. The use of acetylene black crushed into superfine particles of 0.1 to 0.5 μm in size is particularly preferable because the necessary amount of carbon can be reduced. A method of mixing these is physical mixing, ideally, uniform mixing. Therefore, dry or wet mixing using a powder mixer such as a V-type mixer, a S-type mixer, an automated mortar, a ball mill, or a planetary ball mill can be employed.

As the binder, generally, a single material of, or a mixture including two or more of the following can be used: thermoplastic resins such as polytetrafluoroethylene (PTFE), polyvinylidene fluoride (PVDF), polyethylene, and polypropylene; and rubber-elastic polymers such as ethylene-propylene-diene terpolymer (EPDM), sulfonated EPDM, styrene butadiene rubber (SBR), and fluorine rubber. The amount of the binder added is preferably 1 to 50 wt. %, more preferably 2 to 30 wt. %, relative to the total weight of the positive electrode active material layer or the negative electrode active material layer.

As the thickener, generally, a single material of, or a mixture including two or more of the following can be used: polysaccharides such as carboxylmethyl cellulose and methyl cellulose. The functional group of the thickener having a functional group which reacts with lithium like the polysaccharide is preferably deactivated by methylation or the like. The amount of the thickener added is preferably 0.5 to 10 wt. %, more preferably 1 to 2 wt. %, relative to the total weight of the positive electrode active material layer or the negative electrode active material layer.

The material of the filler may be any material as long as the battery performance is not adversely affected. As such a material, generally, an olefin-based polymer such as polypropylene or polyethylene, amorphous silica, alumina, zeolite, glass, carbon, or the like is used. The amount of the filler added is preferably 30 wt. % or less relative to the total weight of the positive electrode active material layer or the negative electrode active material layer.

The positive electrode active material layer or the negative electrode active material layer is manufactured suitably as follows. That is, a mixture is obtained by kneading the main constituent component and the other materials. This mixture is mixed with an organic solvent such as N-methylpyrrolidone or toluene. The resulting mixture solution is heated for approximately 2 hours at approximately 50° C. to 250° C. after the solution is applied or pressed onto the current collector. The method of applying the solution includes, for example, roller coating using an applicator roll or the like, screen coating, a doctor blade method, spin coating, or a method using a bar coater or the like. The method of applying the solution is not limited to these. The mixture solution is preferably applied to have an arbitrary thickness and an arbitrary shape.

For the current collector of the electrode, iron, copper, stainless steel, nickel, and aluminum can be used. The shape thereof may be a sheet, a foam, a mesh, a porous body, an expandable lattice, or the like. Further, a current collector provided with a hole having an arbitrary shape may be used.

A material generally suggested as the material for use in a lithium battery or the like can be used as a nonaqueous electrolyte. For example, a nonaqueous solvent used as the nonaqueous electrolyte includes: cyclic carbonate esters such as propylene carbonate, ethylene carbonate, butylene carbonate, chloroethylene carbonate, and vinylene carbonate; cyclic esters such as γ-butyrolactone and γ-valerolactone; chain carbonates such as dimethyl carbonate, diethyl carbonate, and ethyl methyl carbonate; chain esters such as methyl formate, methyl acetate, and methyl butyrate; tetrahydrofuran or derivatives thereof; ethers such as 1,3-dioxane, 1,4-dioxane, 1,2-dimethoxyethane, 1,4-dibutoxyethane, and methyl diglyme; nitriles such as acetonitrile and benzonitrile; dioxolane or derivatives thereof; and ethylene sulfide, sulfolane, sultone, or derivatives thereof. Any of these may be used alone, or two or more of these may be used as a mixture. The nonaqueous electrolyte is not limited to these.

Moreover, a combination including an electrolyte solution and a solid electrolyte may be used. As the solid electrolyte, a crystalline or amorphous inorganic solid electrolyte can be used. As the crystalline inorganic solid electrolyte, thio-LISICON may be used. Typical thio-LISICON is LiI, Li₃N, Li₁₊ₓMₓTi₂₋ₓ(PO₄)₃ (M=Al, Sc, Y or La), Li_{0.5-3x}R_{0.5+x}TiO₃ (R=La, Pr, Nd, or Sm), or Li₄₋ₓGe₁₋ₓS₄. The applicable amorphous inorganic solid electrolyte includes, for example, LiI—Li₂O—B₂O₅, Li₂O—SiO₂, LiI—Li₂S—B₂S₃, LiI—Li₂S—SiS₂, and Li₂S—SiS₂—Li₃PO₄.

For example, the electrolyte salt used for the nonaqueous electrolyte includes: an inorganic ion salt containing one kind of lithium (Li), sodium (Na), and potassium (K), such as LiClO₄, LiBF₄, LiAsF₄, LiPF₆, LiSCN, LiBr, LiI, Li₂SO₄, Li₂B₁₀Cl₁₀, NaClO₄, NaI, NaSCN, NaBr, KClO₄ or KSCN; and an organic ion salt such as LiCF₃SO₃, LiN(CF₃SO₂)₂, LiN(C₂F₂SO₂)₂, LiN(CF₃SO₂)(C₄F₉SO₂), LiC(CF₃SO₂)₃, LiC(C₂F₅SO₂)₃, (CH₃)₄NBF₄, (CH₃)₄NBr, (C₂H₅)₄NClO₄, (C₂H₅)₄NI, (C₃H₇)₄NBr, (n-C₄H₉)₄NClO₄, (n-C₄H₉)₄NI, (C₂H₅)₄N-maleate, (C₂H₅)₄N-benzoate, (C₂H₅)₄N-phtalate, lithium stearyl sulfonate, lithium octyl sulfonate, or lithium dodecyl benzene sulfonate. Any of these ionic compounds can be used alone, or two or more kinds thereof may be used as a mixture.

Further, a mixture obtained by mixing LiPF₆ and a lithium salt including a perfluoroalkyl group such as LiN(C₂F₅SO₂)₂ is preferably used. This can decrease the viscosity of the electrolyte further. Therefore, the low-temperature characteristic can be further improved. Moreover, the self-discharge can be suppressed.

As the nonaqueous electrolyte, an ambient temperature molten salt or ionic liquid may be used.

The concentration of the electrolyte salt in the nonaqueous electrolyte is preferably 0.1 mol/l to 5 mol/l, and more preferably 0.5 mol/l to 2.5 mol/l. This can surely provide the nonaqueous electrolyte battery having high battery characteristics.

As the separator for the nonaqueous electrolyte battery a porous film and a nonwoven fabric exhibiting excellent high-rate discharge performance, and the like are preferably used alone or in combination. The material used for the separator for the nonaqueous electrolyte battery includes, for example, a polyolefin-based resin typified by polyethylene and polypropylene, a polyester-based resin typified by polyethylene terephthalate and polybutylene terephthalate, polyvinylidene fluoride, vinylidene fluoride-hexafluoropropylene copolymer, vinylidene fluoride-perfluorovinylether copolymer, vinylidene fluoride-tetrafluoroethylene copolymer, vinylidene fluoride-trifluoroethylene copolymer, vinylidene fluoride-fluoroethylene copolymer, vinylidene fluoride-hexafluoroacetone copolymer, vinylidene fluoride-ethylene copolymer, vinylidene fluoride-propylene copolymer, vinylidene fluoride-trifluoropropylene copolymer, vinylidene fluoride-tetrafluoroethylene-hexafluoropropylene copolymer, and vinylidene fluoride-ethylene-tetrafluoroethylene copolymer.

The porosity of the separator for the nonaqueous electrolyte battery is preferably 98 vol. % or less from the viewpoint of the strength. From the viewpoint of the charging/discharging characteristic, the porosity is preferably 20 vol. % or more.

As the separator for the nonaqueous electrolyte battery, for example, a polymer gel including the electrolyte and a polymer such as acrylonitrile, ethylene oxide, propylene oxide, methyl methacrylate, vinyl acetate, vinyl pyrrolidone, or polyvinylidene fluoride may be used. The use of the gel-form nonaqueous electrolyte can provide an effect of preventing the liquid leakage.

The preferred embodiments of the present invention have been described in detail. However, the present invention is not limited to the above embodiments.

For example, the shape of the nonaqueous electrolyte secondary battery is not limited to the shape illustrated in FIG. 1. For example, the shape of the nonaqueous electrolyte secondary battery may be square, elliptical, coin-like, button-like, or sheet-like.

The active material of this embodiment can be used also as the electrode material of an electrochemical element other than the lithium ion secondary battery. Such an electrochemical element includes a secondary battery other than a lithium ion secondary battery such as a metal lithium secondary battery. In this metal lithium secondary battery, the electrode including the active material obtained according to the present invention is used as a positive electrode, and metal lithium is used as a negative electrode. Such an electrochemical element includes an electrochemical capacitor such as a lithium capacitor. These electrochemical elements can be used for a power source in self-running micromachines, IC cards, or the like or for a dispersed power source arranged on a printed board or in a printed board.

### EXAMPLES

Hereinafter, the present invention is described more specifically with reference to examples. However, the present invention is not limited to the examples below.

### Examples According to the First Embodiment

Examples according to the first embodiment of the present invention are described below.

### Example 2

### [Production of Precursor]

In distilled water, 12.70 g of lithium nitrate, 3.10 g of cobalt nitrate hexahydrate, 24.60 g of manganese nitrate hexahydrate, and 7.55 g of nickel nitrate hexahydrate were dissolved to give a raw-material mixture of a precursor. To the raw-material mixture, 0.3 g of glucose and 1 ml of nitric acid were added and 15 ml of polyvinyl alcohol (1 wt. % aqueous solution) was then added. This raw-material mixture was stirred on a hot plate heated to 200° C. until the distilled water was vaporized. This resulted in a black powder (precursor of Example 2). In other words, the precursor of Example 2 was obtained by evaporation to dryness of the raw-material mixture. The molar numbers of Li, Ni, Co, and Mn contained in the precursor were adjusted so as to correspond to 0.15 mol of Li_{1.2}Ni_{0.17}Co_{0.08}Mn_{0.55}O₂ by adjusting the mixing amounts of lithium nitrate, nickel nitrate hexahydrate, cobalt nitrate, and manganese acid hexahydrate in the raw-material mixture. In other words, the molar number of each element in the precursor was adjusted so that 0.15 mol of Li_{1.2}Ni_{0.17}Co_{0.08}Mn_{0.55}O₂ was generated from the precursor of Example 2. Relative to the molar number of 0.15 mol of the active material obtained from the precursor of Example 2, 0.3 g (0.00167 mol) of glucose added to the raw-material mixture accounted for 1.11 mol %.

### [BET Specific Surface Area of Precursor]

The precursor of Example 2 was crushed for approximately 10 minutes in a mortar. Thus, the specific surface area of the precursor was adjusted. The BET specific surface area of the precursor of Example 2 after the crushing was 2.0 m²/g. Note that the BET specific surface area was measured using the Fully Automatic Powder Specific Surface Area Meter, Type AMS8000, manufactured by Okura Riken. In this measurement, nitrogen was used as adsorption gas, helium was used as carrier gas, and single-point BET surface area measurement by a continuous flow method was employed. Specifically, the precursor in a powder form was heated and degassed at a temperature of 150° C. using the mixture gas. Next, the precursor was cooled to liquid nitrogen temperature, thereby making the mixture gas adsorbed on the precursor. After the adsorption of the mixture gas, the precursor was heated up to room temperature with water. This heating resulted in the desorption of the nitrogen gas. The desorption amount of the nitrogen gas was detected by a thermal conductivity detector. From the result, the specific surface area of the precursor was calculated.

### [Crystallization Temperature of Precursor]

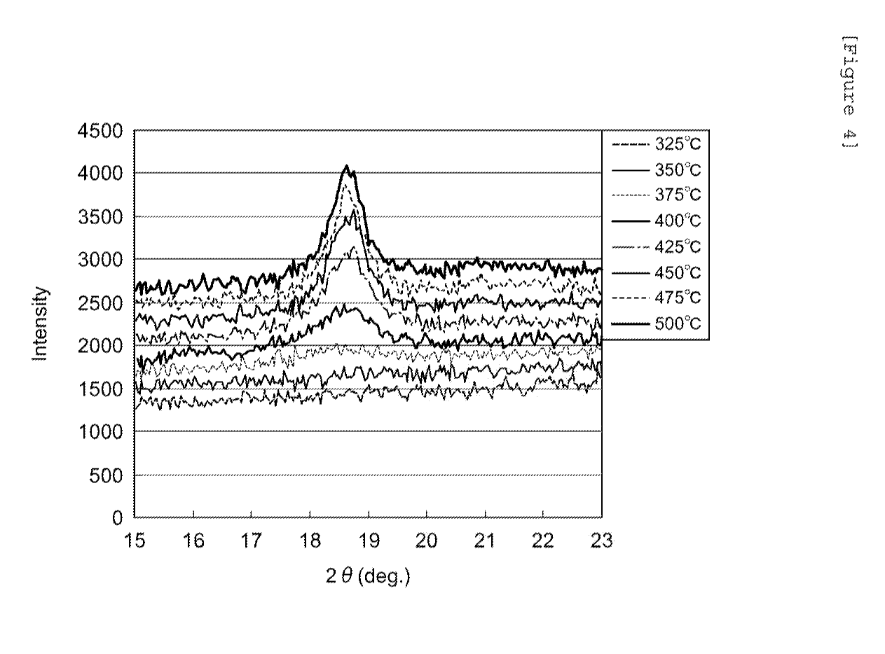

While the temperature of the precursor was increased from room temperature by every 5° C. in the atmospheric air, the X-ray diffraction measurement of the precursor was performed at each temperature. Thus, the crystallization temperature of the precursor of Example 2 was measured. When the temperature of the precursor has reached 400° C., a peak corresponding to the diffraction angle 2θ in the vicinity of 18 to 19° was confirmed (see FIG. 4). This peak corresponds to the (003)-plane of the space group R(-3)m structure of a rhombohedral system. In other words, it was understood that the precursor of Example 2 was crystallized.

Note that MPD manufactured by PANalytical was used as the X-ray diffraction measurement apparatus. The X-ray diffraction measurement was performed under the following conditions:

Step size [° 2Th.]: 0.0334
Scan step time [s]: 10.160
Divergence slit (DS) type: automatic
Irradiation region [mm²]: 15×10
Measurement temperature region [° C.]: 25.00 to 950
Temperature step [° C.]: 5
Measurement atmosphere: atmospheric air
Temperature rising speed: 50° C./min

### Filter: Ni

### Target: Cu K-Alpha

### [Angstroms]: 1.54060

X-ray output setting: 40 mA, 45 kV

### [Production of Active Material]

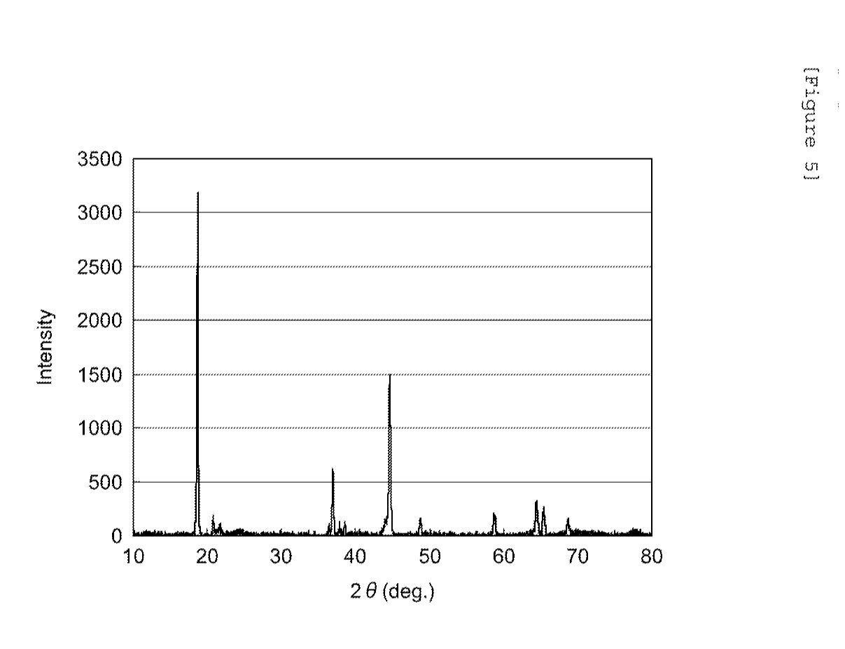

The precursor was heated in the atmospheric air for 10 hours at 900° C., thereby providing the active material of Example 2. The crystal structure of the active material of Example 2 was analyzed by a powder X-ray diffraction method. The active material of Example 2 was confirmed to have the main phase of the space group R(-3)m structure of a rhombohedral system. Moreover, the diffraction peak peculiar to the space group C2/m structure of a monoclinic system of Li₂MnO₃ type was observed at a portion of the pattern of the X-ray diffraction of the active material of Example 2 corresponding to 2θ in the vicinity of 20 to 25° (see FIG. 5).

The result of analyzing the composition by an inductively coupled plasma method (ICP method) confirmed that the composition of the active material of Example 2 was Li_{1.2}Ni_{0.17}Co_{0.08}Mn_{0.55}O₂. It was also confirmed that the molar ratio of the metal elements included in the active material of Example 2 matched the molar ratio of the metal elements included in the precursor of Example 2. In other words, it was confirmed that the composition of the active material obtained from the precursor could be accurately controlled by adjusting the molar ratio of the metal elements in the precursor.

### [Production of Positive Electrode]

A coating for the positive electrode was prepared by mixing the active material of Example 2, a conductive agent, and a solvent including a binder. This coating for the positive electrode was applied to an aluminum foil (thickness: 20 μm) as the current collector by a doctor blade method. Then, the coating for the positive electrode was dried at 100° C. and rolled. Thus, the positive electrode including the positive electrode active material layer and the current collector was obtained. As the conductive agent, carbon black (DAB50, manufactured by DENKI KAGAKU KOGYO KABUSHIKI KAISHA) and graphite were used. As the solvent including the binder, N-methyl-2-pyrrolidinone (KF7305, manufactured by KUREHA CORPORATION) in which PVDF was dissolved was used.

### [Production of Negative Electrode]

A coating for the negative electrode was prepared by a method similar to the method for forming the coating for the positive electrode except that natural graphite was used instead of the active material of Example 2 and that only carbon black was used as the conductive agent. This coating for the negative electrode was applied to a copper foil (thickness: 16 μm) as a current collector by a doctor blade method. After that, the coating for the negative electrode was dried at 100° C. and rolled. This has provided the negative electrode including the negative electrode active material layer and the current collector.

### [Production of Lithium Ion Secondary Battery]

The positive electrode, the negative electrode, and the separator (microporous film made of polyolefin) produced as above were cut into predetermined dimensions. The positive electrode and the negative electrode each had a portion where the coating for the electrode was not applied, so that the portion is used for welding an external leading-out terminal. The positive electrode, the negative electrode, and the separator were stacked in this order. For stacking the positive electrode, the negative electrode, and the separator while avoiding the displacement from one another, these were fixed by applying a small amount of hot-melt adhesive (ethylene-methacrylic acid copolymer, EMAA) thereto. To each of the positive electrode and the negative electrode, an aluminum foil (with a width of 4 mm, a length of 40 mm, and a thickness of 100 μm) or a nickel foil (with a width of 4 mm, a length of 40 mm, and a thickness of 100 μm) was welded with ultrasonic waves as an external leading-out terminal. Around this external leading-out terminal, polypropylene (PP) as grafted maleic anhydride was wound and thermally adhered. This is to improve the sealing property between the external terminal and an exterior body. As the exterior body of the battery, an aluminum laminated material including a PET layer, an Al layer, and a PP layer was used. Into this exterior body of the battery, a battery element as the stacked positive electrode, negative electrode, and separator is sealed. The thicknesses of the PET layer, the Al layer, and the PP layer were 12 μm, 40 μm, and 50 μm, respectively. Note that PET stands for polyethylene terephthalate and PP stands for polypropylene. In the production of the exterior body of the battery, the PP layer was disposed inside the exterior body. Into this exterior body, the battery element was put and an appropriate amount of electrolyte solution was added. Further, the exterior body was sealed to vacuum. Thus, the lithium ion secondary battery of Example 2 was produced. As the electrolyte solution, a mixed solvent including ethylene carbonate (EC) and dimethylcarbonate (DMC), in which 1 M LiPF₆ was dissolved, was used. The volume ratio between EC and DMC in the mixed solvent was EC:DMC=30:70.

### [Measurement of Electric Characteristic]

The battery of Example 2 was charged at a constant current of 30 mA/g up to 4.6 V. Then, this battery was discharged at a constant current of 30 mA/g down to 2.0 V. On this occasion, the discharge capacity of Example 2 was 230 mAh/g. A cycle test was performed in which this charging/discharging cycle was repeated for 100 times. The test was performed at 25° C. When the initial discharge capacity of the battery of Example 2 was assumed 100%, the discharge capacity thereof after 100 cycles was 90%. The percentage of the discharge capacity after the 100 cycles relative to 100% of the initial discharge capacity is called cycle characteristic below. A high cycle characteristic represents the excellent charging/discharging cycle durability of the battery.

### Examples 1 and 3 to 5, and Comparative Examples 2 and 3

In each of Examples 1 and 3 to 5 and Comparative Examples 2 and 3, the raw-material mixture of the precursor was prepared so that the composition of the active material obtained after the sintering was as shown in Table 1. Except for this matter, a method similar to that of Example 2 was employed to produce the precursors, the active materials, and the lithium ion secondary batteries of Examples 1 and 3 to 5 and Comparative Examples 2 and 3.

The crystallization temperatures of the precursors of Examples 1 and 3 to 5 and Comparative Examples 2 and 3 were measured by a method similar to that of Example 2. The compositions and crystal structures of the active materials of Examples 1 and 3 to 5 and Comparative Examples 2 and 3 were analyzed by a method similar to that of Example 2. The discharge capacity and the cycle characteristic of the batteries of Examples 1 and 3 to 5 and Comparative Examples 2 and 3 were evaluated by a method similar to that of Example 2. The results are shown in Table 1. Note that the composition shown in the table below represents the composition of each active material. Moreover, in the table below, a battery having a capacity of 210 mAh/g or more and a cycle characteristic of 85% or more is evaluated as “A”. A battery having a capacity of less than 210 mAh/g and a cycle characteristic of less than 85% is evaluated as “F”.

### Example 29

In Example 29, the raw-material mixture of the precursor was prepared so that the composition of the active material obtained after the sintering was as shown in Table 1. In other words, in Example 29, only 12.70 g of lithium nitrate, 26.20 g of manganese nitrate hexahydrate, and 8.80 g of nickel nitrate hexahydrate were used as the metal salt included in the raw-material mixture of the precursor. In Example 29, the specific surface area of the precursor was adjusted to 2.0 m²/g by crushing the obtained precursor in a mortar for approximately 10 minutes.

Except for the above matter, a method similar to that of Example 2 was employed to produce the precursor, the active material, and the lithium ion secondary batter) according to Example 29.

The crystallization temperature of the precursor of Example 29 was measured by a method similar to that of Example 2. The composition and crystal structure of the active material of Example 29 were analyzed by a method similar to that of Example 2. The discharge capacity and the cycle characteristic of the batter) of Example 29 were evaluated by a method similar to that of Example 2. The results are shown in Table 1.

### Comparative Example 4

In Comparative Example 4, a precursor having a composition corresponding to the active material represented by Li_{1.2}Ni_{0.17}Co_{0.08}Mn_{0.55}O₂ was produced by the coprecipitation method shown below.

In the coprecipitation method, first, 0.5 liter of water was put into a reaction tank. Further, a 32% aqueous sodium hydroxide solution was added to the water so that the pH thereof became 11 to 11.5. Next, the temperature of the solution in the reaction tank was maintained at 50° C. by heating the water with an external heater while the water is stirred. Separately from this, a material solution was prepared in which nickel sulfate hexahydrate, cobalt sulfate heptahydrate, and manganese sulfate pentahydrate were dissolved so that the molar ratio among Ni, Co. and Mn became 0.17:0.08:0.55. This material solution was dropped into the reaction tank continuously at a flow rate of approximately 3 ml/min. Moreover, a 32% aqueous sodium hydroxide solution was put into the reaction tank intermittently so that the pH was maintained at 11 to 11.5. Moreover, the temperature of the solution in the reaction tank was controlled intermittently by a heater so as to be constantly maintained at 50° C. After the total amount of the material solution was dropped, the stirring and heating were stopped. Then, the content of the reaction tank was stood still overnight. Next, a slurry of a precipitate was taken out of the reaction tank. The taken slurry was washed with water and filtrated, and then dried at 110° C. overnight. This resulted in a dried powder of coprecipitated hydroxide. The obtained dried powder and a predetermined amount of powder of lithium hydroxide monohydrate were mixed to provide the precursor of Comparative Example 4.

Except for the above matter, a method similar to that of Example 2 was employed to produce the precursor, the active material, and the lithium ion secondary battery according to Comparative Example 4.

The crystallization temperature of the precursor of Comparative Example 4 was measured by a method similar to that of Example 2. The composition and crystal structure of the active material of Comparative Example 4 were analyzed by a method similar to that of Example 2. The discharge capacity and the cycle characteristic of the battery of Comparative Example 4 were evaluated by a method similar to that of Example 2. The results are shown in Table 1. Note that as shown in Table 1, the crystallization temperature of Comparative Example 4 was higher than those in the examples. This is because, according to the present inventors, the composition distribution of Li, Ni, Co, and Mn in the precursor in Comparative Example 4 has become non-uniform due to the use of the coprecipitation method for forming the precursor of Comparative Example 4, which is different from the method in the examples.

TABLE 1

| | | crystallization temperature | capacity | cycle characteristic | |
|---|---|---|---|---|---|
| | composition formula | ° C. | mAh/g | % | evaluation |
| Example 29 | Li_{1.2}Ni_{0.2}Mn_{0.6}O₂ | 425 | 220 | 88 | A |
| Example 1 | Li_{1.2}Ni_{0.17}Co_{0.03}Mn_{0.6}O₂ | 400 | 230 | 90 | A |
| Example 2 | Li_{1.2}Ni_{0.17}Co_{0.08}Mn_{0.55}O₂ | 400 | 230 | 90 | A |
| Example 3 | Li_{1.2}Ni_{0.15}Co_{0.1}Mn_{0.55}O₂ | 420 | 220 | 90 | A |
| Example 4 | Li_{1.2}Ni_{0.13}Co_{0.13}Mn_{0.54}O₂ | 430 | 210 | 88 | A |
| Example 5 | Li_{1.2}Ni_{0.12}Co_{0.25}Mn_{0.43}O₂ | 445 | 210 | 90 | A |
| Comparative Example 2 | Li_{1.2}Ni_{0.10}Co_{0.3}Mn_{0.4}O₂ | 455 | 210 | 80 | F |
| Comparative Example 3 | Li_{1.2}Co_{0.3}Mn_{0.5}O₂ | 460 | 180 | 85 | F |
| Comparative Example 4 | Li_{1.2}Ni_{0.17}Co_{0.08}Mn_{0.55}O₂ | 500 | 190 | 85 | F |

### Examples 6, 7, 27, and 28

In Example 6, an agglomerate of the precursor after evaporation to dryness was roughly crushed instead of crushing the precursor in a mortar. Thus, the specific surface area of the precursor was adjusted to the value shown in Table 2. In Example 7, the precursor was crushed using a bead mill instead of crushing the precursor in a mortar. Thus, the specific surface area of the precursor was adjusted to the value shown in Table 2. In Example 27, the precursor after the evaporation to dryness was not crushed. Therefore, the specific surface area of the precursor corresponded to the value shown in Table 2. In Example 28, the precursor was crushed using a planetary ball mill instead of crushing the precursor in a mortar. Thus, the specific surface area of the precursor was adjusted to the value shown in Table 2.

Except for the above matter, a method similar to that of Example 2 was employed to produce the precursors, the active materials, and the lithium ion secondary batteries of Examples 6, 7, 27, and 28. The crystallization temperatures of the precursors of Examples 6, 7, 27, and 28 were measured by a method similar to that of Example 2. The compositions and crystal structures of the active materials of Examples 6, 7, 27, and 28 were analyzed by a method similar to that of Example 2. The discharge capacity and the cycle characteristic of the batteries of Examples 6, 7, 27, and 28 were evaluated by a method similar to that of Example 2. The results are shown in Table 2. Note that the composition of each of the active materials of Examples 6, 7, 27, and 28 is Li_{1.2}Ni_{0.17}Co_{0.08}Mn_{0.55}O₂, which is similar to that of Example 2.

TABLE 2

| | | crystal- | | cycle | |
|---|---|---|---|---|---|
| | BET specific | lization | | charac- | |
| | surface area | temperature | capacity | teristic | evalua- |
| | m²/g | ° C. | mAh/g | % | tion |
| Example 27 | 0.3 | 440 | 215 | 88 | A |
| Example 6 | 0.5 | 430 | 220 | 92 | A |
| Example 2 | 2.0 | 400 | 230 | 90 | A |
| Example 7 | 6.0 | 400 | 230 | 90 | A |
| Example 28 | 7.0 | 400 | 234 | 85 | A |

### Examples 8 and 9 and Comparative Examples 7 and 8

In each of Examples 8 and 9 and Comparative Examples 7 and 8, the amount of glucose added to the raw-material mixture of the precursor was adjusted to the value shown in Table 3. In other words, in Examples 8 and 9 and Comparative Examples 7 and 8, the ratio (mol %) of glucose to the mol number of 0.15 mol of the active material obtained from the precursor was adjusted to the value shown in Table 3.

Except for the above matter, a method similar to that of Example 2 was employed to produce the precursors, the active materials, and the lithium ion secondary batteries of Examples 8 and 9 and Comparative Examples 7 and 8. The crystallization temperatures of the precursors of Examples 8 and 9 and Comparative Examples 7 and 8 were measured by a method similar to that of Example 2. The compositions and crystal structures of the active materials of Examples 8 and 9 and Comparative Examples 7 and 8 were analyzed by a method similar to that of Example 2. The discharge capacity and the cycle characteristic of the batteries of Examples 8 and 9 and Comparative Examples 7 and 8 were evaluated by a method similar to that of Example 2. The results are shown in Table 3. Note that the composition of each of the active materials of Examples 8 and 9 and Comparative Examples 7 and 8 is Li_{1.2}Ni_{0.17}Co_{0.08}Mn_{0.55}O₂, which is similar to that of Example 2.

TABLE 3

| | | | | crystallization | | cycle | |
|---|---|---|---|---|---|---|---|
| | glucose | | | temperature | capacity | characteristic | |
| | g | mol | mol % | ° C. | mAh/g | % | evaluation |
| Example 8 | 0.595 | 0.00330 | 2.20 | 405 | 230 | 90 | A |
| Example 2 | 0.3 | 0.00167 | 1.11 | 400 | 230 | 90 | A |
| Example 9 | 0.022 | 0.00012 | 0.08 | 405 | 220 | 88 | A |
| Comparative | 0.014 | 0.00008 | 0.05 | 455 | 200 | 80 | F |
| Example 7 | | | | | | | |
| Comparative | 0 | 0 | 0.00 | 455 | 195 | 80 | F |
| Example 8 | | | | | | | |

### Examples 10 to 13

In Example 10, the amount of sucrose added to the raw-material mixture of the precursor was adjusted to the value shown in Table 4. In Example 11, the amount of fructose added to the raw-material mixture of the precursor was adjusted to the value shown in Table 4. In Example 12, the amount of ascorbic acid added to the raw-material mixture of the precursor was adjusted to the value shown in Table 4. In Example 13, the amount of glucuronic acid added to the raw-material mixture of the precursor was adjusted to the value shown in Table 4. In other words, the ratios (mol %) of a sugar and a sugar acid relative to the mol number of 0.15 mol of the active material obtained from the precursor were adjusted to the values shown in Table 4 in Examples 10, 11, 12, and 13.

Except for the above matter, a method similar to that of Example 2 was employed to produce the precursors, the active materials, and the lithium ion secondary batteries of Examples 10, 11, 12, and 13. The crystallization temperatures of the precursors of Examples 10, 11, 12 and 13 were measured by a method similar to that of Example 2. The compositions and crystal structures of the active materials of Examples 10, 11, 12, and 13 were analyzed by a method similar to that of Example 2. The discharge capacity and the cycle characteristic of the batteries of Examples 10, 11. 12, and 13 were evaluated by a method similar to that of Example 2. The results are shown in Table 4. Note that the specific surface area of the precursor of each of Examples 10, 11, 12 and 13 was 2.0 m²/g. Moreover, the composition of the active material of each of Examples 10, 11, 12, and 13 was Li_{1.2}Ni_{0.17}Co_{0.08}Mn_{0.55}O₂, which is similar to that of Example 2.

TABLE 4

| | | | crystal- | | | |
|---|---|---|---|---|---|---|
| | | | lization | | cycle | |
| | | | temper- | capac- | charac- | |
| | sugar and | ratio | ature | ity | teristic | evalua- |
| | sugar acid | mol % | ° C. | mAh/g | % | tion |
| Example 10 | sucrose | 1.11 | 405 | 228 | 91 | A |
| Example 11 | fructose | 1.11 | 400 | 230 | 88 | A |
| Example 12 | ascorbic | 1.11 | 405 | 227 | 90 | A |
| | acid | | | | | |
| Example 13 | glucuronic | 1.11 | 405 | 228 | 90 | A |
| | acid | | | | | |

### Examples 14 to 26 and 30, and Comparative Example 9

In Example 14, aluminum nitrate nonahydrate was used as an Al source of the raw-material mixture of the precursor. In Example 15, silicon dioxide was used as a Si source of the raw-material mixture of the precursor. In Example 16, zirconium nitrate oxide dihydrate was used as a Zr source of the raw-material mixture of the precursor. In Example 17, titanium sulfate hydroxide was used as a Ti source of the raw-material mixture of the precursor. In Example 18, magnesium nitrate hexahydrate was used as a Mg source of the raw-material mixture of the precursor. In Example 19, niobium oxide was used as a Nb source of the raw-material mixture of the precursor. In Example 20, barium carbonate was used as a Ba source of the raw-material mixture of the precursor. In Example 21, vanadium oxide was used as a V source of the raw-material mixture of the precursor. In Example 30, iron sulfate heptahydrate was used as a Fe source of the raw-material mixture of the precursor. In Example 26 and Comparative Example 9, lithium fluoride was used as a F source of the raw-material mixture of the precursor.

Then, the raw-material mixture of the precursor was prepared so that the composition of the active material obtained after the sintering was as shown in Table 5 in Examples 14 to 26 and 30 and Comparative Example 9. Except for the above matter, a method similar to that of Example 2 was employed to produce the precursors, the active materials, and the lithium ion secondary batteries of Examples 14 to 26 and 30 and Comparative Example 9.

The crystallization temperatures of the precursors of Examples 14 to 26 and 30 and Comparative Example 9 were measured by a method similar to that of Example 2. The compositions and crystal structures of the active materials of Examples 14 to 26 and 30 and Comparative Example 9 were analyzed by a method similar to that of Example 2. The discharge capacity and the cycle characteristic of the batteries of Examples 14 to 26 and 30 and Comparative Example 9 were evaluated by a method similar to that of Example 2. The results are shown in Table 5.

TABLE 5

| | | crystallization temperature | capacity | cycle characteristic | |
|---|---|---|---|---|---|
| | composition formula | ° C. | mAh/g | % | evaluation |
| Example 14 | Li_{1.2}Ni_{0.16}Co_{0.03}Mn_{0.6}Al_{0.01}O₂ | 400 | 230 | 92 | A |
| Example 15 | Li_{1.2}Ni_{0.16}Co_{0.03}Mn_{0.6}Si_{0.01}O₂ | 395 | 230 | 92 | A |
| Example 16 | Li_{1.2}Ni_{0.16}Co_{0.03}Mn_{0.6}Zr_{0.01}O₂ | 395 | 230 | 92 | A |
| Example 17 | Li_{1.2}Ni_{0.16}Co_{0.03}Mn_{0.6}Ti_{0.01}O₂ | 400 | 230 | 92 | A |
| Example 18 | Li_{1.2}Ni_{0.16}Co_{0.03}Mn_{0.6}Mg_{0.01}O₂ | 400 | 230 | 92 | A |
| Example 19 | Li_{1.2}Ni_{0.16}Co_{0.03}Mn_{0.6}Nb_{0.01}O₂ | 400 | 230 | 92 | A |
| Example 20 | Li_{1.2}Ni_{0.16}Co_{0.03}Mn_{0.6}Ba_{0.01}O₂ | 400 | 230 | 92 | A |
| Example 21 | Li_{1.2}Ni_{0.16}Co_{0.03}Mn_{0.6}V_{0.01}O₂ | 400 | 230 | 92 | A |
| Example 22 | Li_{1.05}Ni_{0.2}Co_{0.10}Mn_{0.65}O₂ | 405 | 215 | 90 | A |
| Example 23 | Li_{1.15}Ni_{0.12}Co_{0.25}Mn_{0.48}O₂ | 415 | 210 | 90 | A |
| Example 24 | Li_{1.3}Ni_{0.1}Co_{0.10}Mn_{0.5}O₂ | 425 | 210 | 90 | A |
| Example 25 | Li_{1.2}Ni_{0.3}Co_{0.10}Mn_{0.4}O₂ | 425 | 220 | 90 | A |
| Example 26 | Li_{1.2}Ni_{0.17}Co_{0.08}Mn_{0.55}O_{1.9}F_{0.15} | 400 | 230 | 93 | A |
| Comparative Example 9 | Li_{1.2}Ni_{0.17}Co_{0.08}Mn_{0.55}O_{1.8}F_{0.2} | 400 | 190 | 95 | F |
| Example 30 | Li_{1.2}Ni_{0.16}Co_{0.03}Mn_{0.6}Fe_{0.01}O₂ | 400 | 230 | 92 | A |

It was confirmed that the composition of the active material of each example shown in Tables 1 to 5 was in the range of the following composition formula (I). It was confirmed that the crystallization temperature of the precursor of each example was 450° C. or less. It was confirmed that the active material formed from the precursor of each example had the space group R(-3)m structure of a rhombohedral system.

Li_{y}NiₐCO_{b}Mn_{c}M_{d}OₓF_{z} (1)

wherein the element M is at least one element selected from the group consisting of Al, Si, Zr, Ti, Fe, Mg, Nb, Ba, and V and 1.9≦(a+b+c+d+y)≦2.1, 1.0≦y≦1.3, 0<a≦0.3, 0≦b≦0.25, 0.3≦c≦0.7, 0≦d≦0.1, 1.9≦(x+z)≦2.0, and 0≦z≦0.15 are satisfied.

Moreover, it was confirmed that the battery of any example had a discharge capacity of 210 mAh/g or more and a cycle characteristic of 85% or more.

It was confirmed that the active material formed from the precursor of each comparative example had the space group R(-3)ₘ structure of a rhombohedral system. However, in the comparative examples, it was confirmed that the crystallization temperature of the precursor was more than 450° C. or that the composition of the active material obtained from the precursor was out of the range of the composition formula (1). As a result, it was confirmed that the battery of any comparative example had a capacity of less than 210 mAh/g or a cycle characteristic of less than 85%.

### Examples According to the Second Embodiment

Examples according to the second embodiment of the present invention are described below.

### Example 102

### [Production of Precursor]

In distilled water, 12.70 g of lithium nitrate, 3.10 g of cobalt nitrate hexahydrate, 24.60 g of manganese nitrate hexahydrate, and 7.55 g of nickel nitrate hexahydrate were dissolved to give a raw-material mixture of a precursor. To the raw-material mixture, 0.3 g of glucose and 1 ml of nitric acid were added, and 15 ml of polyvinyl alcohol (1 wt. % aqueous solution) was then added. This raw-material mixture was stirred on a hot plate heated to 200° C. until the distilled water was vaporized. This resulted in a black powder (precursor of Example 102). In other words, the precursor of Example 102 was obtained by evaporation to dryness of the raw-material mixture. The molar numbers of Li, Ni, Co, and Mn contained in the precursor were adjusted so as to correspond to 0.15 mol of Li_{1.2}Ni_{0.17}Co_{0.08}Mn_{0.55}O₂ by adjusting the mixing amounts of lithium nitrate, nickel nitrate hexahydrate, cobalt nitrate, and manganese acid hexahydrate in the raw-material mixture. In other words, the molar number of each element in the precursor was adjusted so that 0.15 mol of Li_{1.2}Ni_{0.17}Co_{0.08}Mn_{0.55}O₂ was generated from the precursor of Example 102. Relative to the molar number of 0.15 mol of the active material obtained from the precursor of Example 102, 0.3 g (0.00167 mol) of glucose added to the raw-material mixture accounted for 1.11 mol %.

### [BET Specific Surface Area of Precursor]

The precursor of Example 102 was crushed for approximately 10 minutes in a mortar. Thus, the specific surface area of the precursor was adjusted. The BET specific surface area of the precursor of Example 102 after the crushing was 2.0 m²/g. Note that the BET specific surface area was measured using the Fully Automatic Powder Specific Surface Area Meter, Type AMS8000, manufactured by Okura Riken. In this measurement, nitrogen was used as adsorption gas, helium was used as carrier gas, and single-point BET surface area measurement by a continuous flow method was employed. Specifically, the precursor in a powder form was heated and degassed at a temperature of 150° C. using the mixture gas. Next, the precursor was cooled to liquid nitrogen temperature, thereby making the mixture gas adsorbed on the precursor. After the adsorption of the mixture gas, the precursor was heated up to room temperature with water. This heating resulted in the desorption of the nitrogen gas. The desorption amount of the nitrogen gas was detected by a thermal conductivity detector. From the result, the specific surface area of the precursor was calculated.

### [Differential Thermal Analysis of Precursor]

The endothermic peak temperature of the precursor of Example 102 was measured according to the differential thermal analysis. The endothermic peak temperature of the precursor of Example 102 was 470° C.

Note that TG-8120 manufactured by Rigaku Corporation was used as the differential thermal analysis apparatus. The differential thermal analysis was performed under the following conditions:

Mass of the precursor of Example 102 used in the differential thermal analysis: 30 mg
Measurement temperature range: 25.00 to 950° C.
Measurement atmosphere: atmospheric air flow
Temperature rising speed of the precursor: 10° C./min
Standard sample: alumina powder

### [Production of Active Material]

The precursor was heated in the atmospheric air for 10 hours at 900° C., thereby providing the active material of Example 102. The crystal structure of the active material of Example 102 was analyzed by a powder X-ray diffraction method. The active material of Example 102 was confirmed to have the main phase of the space group R(-3)ₘ structure of a rhombohedral system. Moreover, the diffraction peak, peculiar to the space group C2/m structure of a monoclinic system of Li₂MnO₃ type, was observed at a portion of the pattern of the X-ray diffraction of the active material of Example 102 corresponding to 20 in the vicinity of 20 to 25° (see FIG. 5).

The result of analyzing the composition by an inductively coupled plasma method (ICP method) confirmed that the composition of the active material of Example 102 is Li_{1.2}Ni_{0.17}Co_{0.08}Mn_{0.55}O₂. It also confirmed that the molar ratio of the metal elements included in the active material of Example 102 matched the molar ratio of the metal elements included in the precursor of Example 102. In other words, it was confirmed that the composition of the active material obtained from the precursor cold be accurately controlled by adjusting the molar ratio of the metal elements in the precursor.

### [Production of Positive Electrode]

A coating for the positive electrode was prepared by mixing the active material of Example 102, a conductive agent, and a solvent including a binder. This coating for the positive electrode was applied to an aluminum foil (thickness: 20 μm) as the current collector by a doctor blade method. Then, the coating for the positive electrode was dried at 100° C. and rolled. Thus, the positive electrode including the positive electrode active material layer and the current collector was obtained. As the conductive agent, carbon black (DAB50, manufactured by DENKI KAGAKU KOGYO KABUSHIKI KAISHA) and graphite were used. As the solvent including the binder, N-methyl-2-pyrrolidinone (KF7305, manufactured by KUREHA CORPORATION) in which PVDF was dissolved was used.

### [Production of Negative Electrode]

A coating for the negative electrode was prepared by a method similar to the method for forming the coating for the positive electrode except that natural graphite was used instead of the active material of Example 102 and that only carbon black was used as the conductive agent. This coating for the negative electrode was applied to a copper foil (thickness: 16 μm) as a current collector by a doctor blade method. After that, the coating for the negative electrode was dried at 100° C. and rolled. This has provided the negative electrode including the negative electrode active material layer and the current collector.

### [Production of Lithium Ion Secondary Battery]

The positive electrode, the negative electrode, and the separator (microporous film made of polyolefin) produced as above were cut into predetermined dimensions. The positive electrode and the negative electrode each had a portion where the coating for the electrode was not applied, so that the portion is used for welding an external leading-out terminal. The positive electrode, the negative electrode, and the separator were stacked in this order. For stacking the positive electrode, the negative electrode, and the separator while avoiding the displacement from one another, these were fixed by applying a small amount of hot-melt adhesive (ethylene-methacrylic acid copolymer, EMAA) thereto. To each of the positive electrode and the negative electrode, an aluminum foil (with a width of 4 mm, a length of 40 mm, and a thickness of 100 μm) or a nickel foil (with a width of 4 mm, a length of 40 mm, and a thickness of 100 μm) was welded with ultrasonic waves as an external leading-out terminal. Around this external leading-out terminal, polypropylene (PP) as grafted maleic anhydride was wound and thermally adhered. This is to improve the sealing property between the external terminal and an exterior body. As the exterior body of the battery, an aluminum laminated material including a PET layer, an Al layer, and a PP layer was used. Into this exterior body of the battery, a battery element as the stacked positive electrode, negative electrode, and separator is sealed. The thicknesses of the PET layer, the Al layer, and the PP layer were 12 μm, 40 μm, and 50 μm, respectively. Note that PET stands for polyethylene terephthalate and PP stands for polypropylene. In the production of the exterior body of the battery, the PP layer was disposed inside the exterior body. Into this exterior body, the battery element was put and an appropriate amount of electrolyte solution was added. Further, the exterior body was sealed to vacuum. Thus, the lithium ion secondary battery of Example 102 was produced. As the electrolyte solution, a mixed solvent including ethylene carbonate (EC) and dimethylcarbonate (DMC), in which 1 M LiPF₆ was dissolved, was used. The volume ratio between EC and DMC in the mixed solvent was EC:DMC=30:70.

### [Measurement of Electric Characteristic]

The battery of Example 102 was charged at a constant current of 30 mA/g up to 4.6 V Then, this battery was discharged at a constant current of 30 mA/g down to 2.0 V. On this occasion, the discharge capacity of Example 102 was 230 mA/g. A cycle test was performed in which this charging/discharging cycle was repeated for 100 times. The test was performed at 25° C. When the initial discharge capacity of the battery of Example 102 was assumed 100%, the discharge capacity thereof after 100 cycles was 90%. The percentage of the discharge capacity after the 100 cycles relative to 100% of the initial discharge capacity is called cycle characteristic below. A high cycle characteristic represents the excellent charging/discharging cycle durability of the battery.

### Examples 101 and 103 to 105, and Comparative Examples 102 and 103

In each of Examples 101 and 103 to 105 and Comparative Examples 102 and 103, the raw-material mixture of the precursor was prepared so that the composition of the active material obtained after the sintering was as shown in Table 6. Except for this matter, a method similar to that of Example 102 was employed to produce the precursors, the active materials, and the lithium ion secondary batteries of Examples 101 and 103 to 105 and Comparative Examples 102 and 103.

The endothermic peak temperatures of the precursors of Examples 101 and 103 to 105 and Comparative Examples 102 and 103 were measured by a method similar to that of Example 102. The compositions and crystal structures of the active materials of Examples 101 and 103 to 105 and Comparative Examples 102 and 103 were analyzed by a method similar to that of Example 102. The discharge capacity and the cycle characteristic of the batteries of Examples 101 and 103 to 105 and Comparative Examples 102 and 103 were evaluated by a method similar to that of Example 102. The results are shown in Table 6. Note that the composition shown in the table below is the composition of each active material and corresponds to the overall mean composition (starting composition) of the precursor of each active material. Moreover, in the table below, a battery having a capacity of 210 mAh/g or more and a cycle characteristic of 85% or more is evaluated as “A”. A battery having a capacity of less than 210 mAh/g and a cycle characteristic of less than 85% is evaluated as “F”.

### Example 129

In Example 129, the raw-material mixture of the precursor was prepared so that the composition of the active material obtained after the sintering was as shown in Table 6. In other words, in Example 129, only 12.70 g of lithium nitrate, 26.20 g of manganese nitrate hexahydrate, and 8.80 g of nickel nitrate hexahydrate were used as the metal salt included in the raw-material mixture of the precursor. In Example 129, the specific surface area of the precursor was adjusted to 2.0 m²/g by crushing the obtained precursor in a mortar for approximately 10 minutes.

Except for the above matter, a method similar to that of Example 102 was employed to produce the precursor, the active material, and the lithium ion secondary battery according to Example 129.

The endothermic peak temperature of the precursor of Example 129 was measured by a method similar to that of Example 102. The composition and crystal structure of the active material of Example 29 were analyzed by a method similar to that of Example 102. The discharge capacity and the cycle characteristic of the battery of Example 129 were evaluated by a method similar to that of Example 102. The results are shown in Table 6.

### Comparative Example 104

In Comparative Example 104, a precursor having a composition corresponding to the active material represented by Li_{1.2}Ni_{0.17}Co_{0.08}Mn_{0.55}O₂ was produced by the coprecipitation method shown below.

In the coprecipitation method, first, 0.5 liter of water was put into a reaction tank. Further, a 32% aqueous sodium hydroxide solution was added to the water so that the pH thereof became 11 to 11.5. Next, the temperature of the solution in the reaction tank was maintained at 50° C. by heating the water with an external heater while the water is stirred. Separately from this, a material solution was prepared in which nickel sulfate hexahydrate, cobalt sulfate heptahydrate, and manganese sulfate pentahydrate were dissolved so that the molar ratio among Ni, Co, and Mn became 0.17:0.08:0.55. This material solution was dropped into the reaction tank continuously at a flow rate of approximately 3 ml/min. Moreover, a 32% aqueous sodium hydroxide solution was put into the reaction tank intermittently so that the pH was maintained at 11 to 11.5. Moreover, the temperature of the solution in the reaction tank was controlled intermittently by a heater so as to be constantly maintained at 50° C. After the total amount of the material solution was dropped, the stirring and heating were stopped. Then, the content of the reaction tank was stood still overnight. Next, a slurry of a precipitate was taken out of the reaction tank. The taken slurry was washed with water and filtrated, and then dried at 110° C. overnight. This resulted in a dried powder of coprecipitated hydroxide. The obtained dried powder and a predetermined amount of powder of lithium hydroxide monohydrate were mixed to provide the precursor of Comparative Example 104.

Except for the above matter, a method similar to that of Example 102 was employed to produce the precursor, the active material, and the lithium ion secondary battery according to Comparative Example 104.

The endothermic peak temperature of the precursor of Comparative Example 104 was measured by a method similar to that of Example 102. The composition and crystal structure of the active material of Comparative Example 104 were analyzed by a method similar to that of Example 102. The discharge capacity and the cycle characteristic of the battery of Comparative Example 104 were evaluated by a method similar to that of Example 102. The results are shown in Table 6. Note that as shown in Table 6, the endothermic peak temperature of Comparative Example 104 was higher than those in the examples. This is because, according to the present inventors, the composition distribution of Li, Ni, Co, and Mn in the precursor in Comparative Example 104 has become non-uniform due to the use of the coprecipitation method for forming the precursor of Comparative Example 104, which is different from the method in the examples.

TABLE 6

| | | endothermic peak temperature | capacity | cycle characteristic | |
|---|---|---|---|---|---|
| | composition formula | ° C. | mAh/g | % | evaluation |
| Example 129 | Li_{1.2}Ni_{0.2}Mn_{0.6}O₂ | 480 | 220 | 88 | A |
| Example 101 | Li_{1.2}Ni_{0.17}Co_{0.03}Mn_{0.6}O₂ | 480 | 230 | 90 | A |
| Example 102 | Li_{1.2}Ni_{0.17}Co_{0.08}Mn_{0.55}O₂ | 470 | 230 | 90 | A |
| Example 103 | Li_{1.2}Ni_{0.15}Co_{0.1}Mn_{0.55}O₂ | 500 | 220 | 90 | A |
| Example 104 | Li_{1.2}Ni_{0.13}Co_{0.13}Mn_{0.54}O₂ | 510 | 210 | 88 | A |
| Example 105 | Li_{1.2}Ni_{0.12}Co_{0.25}Mn_{0.43}O₂ | 520 | 210 | 90 | A |
| Comparative Example 102 | Li_{1.2}Ni_{0.10}Co_{0.3}Mn_{0.4}O₂ | 555 | 210 | 80 | F |
| Comparative Example 103 | Li_{1.2}Co_{0.3}Mn_{0.5}O₂ | 560 | 180 | 85 | F |
| Comparative Example 104 | Li_{1.2}Ni_{0.17}Co_{0.08}Mn_{0.55}O₂ | 610 | 190 | 85 | F |

### Examples 106, 107, 127, and 128

In Example 106, an agglomerate of the precursor after evaporation to dryness was roughly crushed instead of crushing the precursor in a mortar. Thus, the specific surface area of the precursor was adjusted to the value shown in Table 7. In Example 107, the precursor was crushed using a bead mill instead of crushing the precursor in a mortar. Thus, the specific surface area of the precursor was adjusted to the value shown in Table 7. In Example 127, the precursor after the evaporation to dryness was not crushed. Therefore, the specific surface area of the precursor corresponded to the value shown in Table 7. In Example 128, the precursor was crushed using a planetary ball mill instead of crushing the precursor in a mortar. Thus, the specific surface area of the precursor was adjusted to the value shown in Table 7.

Except for the above matter, a method similar to that of Example 102 was employed to produce the precursors, the active materials, and the lithium ion secondary batteries of Examples 106, 107, 127 and 128. The endothermic peak temperatures of the precursors of Examples 106, 107, 127 and 128 were measured by a method similar to that of Example 102. The compositions and crystal structures of the active materials of Examples 106, 107, 127 and 128 were analyzed by a method similar to that of Example 102. The discharge capacity and cycle characteristics of the batteries of Examples 106, 107, 127 and 128 were evaluated by a method similar to that of Example 102. The results are shown in Table 7. Note that the composition of each of the active materials of Examples 106, 107, 127 and 128 is Li_{1.2}Ni_{0.17}Co_{0.08}Mn_{0.55}O₂, which is similar to that of Example 102.

TABLE 7

| | | endothermic | | cycle | |
|---|---|---|---|---|---|
| | BET specific | peak | | charac- | |
| | surface area | temperature | capacity | teristic | evalua- |
| | m²/g | ° C. | mAh/g | % | tion |
| Example 127 | 0.3 | 505 | 215 | 88 | A |
| Example 106 | 0.5 | 480 | 220 | 92 | A |
| Example 102 | 2 | 470 | 230 | 90 | A |
| Example 107 | 6 | 465 | 230 | 90 | A |
| Example 128 | 7 | 460 | 234 | 85 | A |

### Examples 108 to 119 and 130, and Comparative Example 107

In Example 108, aluminum nitrate nonahydrate was used as an Al source of the raw-material mixture of the precursor. In Example 109, silicon dioxide was used as a Si source of the raw-material mixture of the precursor. In Example 110, zirconium nitrate oxide dihydrate was used as a Zr source of the raw-material mixture of the precursor. In Example 111, titanium sulfate hydroxide was used as a Ti source of the raw-material mixture of the precursor. In Example 112, magnesium nitrate hexahydrate was used as a Mg source of the raw-material mixture of the precursor. In Example 113, niobium oxide was used as a Nb source of the raw-material mixture of the precursor. In Example 114, barium carbonate was used as a Ba source of the raw-material mixture of the precursor. In Example 115, vanadium oxide was used as a V source of the raw-material mixture of the precursor. In Example 130, iron sulfate heptahydrate was used as a Fe source of the raw-material mixture of the precursor. In Example 119 and Comparative Example 107, lithium fluoride was used as a F source of the raw-material mixture of the precursor.

Then, the raw-material mixture of the precursor was prepared so that the composition of the active material obtained after the sintering was as shown in Table 8 in Examples 108 to 119 and 130 and Comparative Example 107. Except for the above matter, a method similar to that of Example 102 was employed to produce the precursors, the active materials, and the lithium ion secondary batteries of Examples 108 to 119 and 130 and Comparative Example 107.

The endothermic peak temperatures of the precursors of Examples 108 to 119 and 130 and Comparative Example 107 were measured by a method similar to that of Example 102. The compositions and crystal structures of the active materials of Examples 108 to 119 and 130 and Comparative Example 107 were analyzed by a method similar to that of Example 102. The discharge capacity and the cycle characteristic of the batteries of Examples 108 to 119 and 130 and Comparative Example 107 were evaluated by a method similar to that of Example 102. The results are shown in Table 8.

TABLE 8

| | | endothermic peak temperature | capacity | cycle characteristic | |
|---|---|---|---|---|---|
| | composition formula | ° C. | mAh/g | % | evaluation |
| Example 108 | Li_{1.2}Ni_{0.16}Co_{0.03}Mn_{0.6}Al_{0.01}O₂ | 480 | 230 | 92 | A |
| Example 109 | Li_{1.2}Ni_{0.16}Co_{0.03}Mn_{0.6}Si_{0.01}O₂ | 480 | 230 | 92 | A |
| Example 110 | Li_{1.2}Ni_{0.16}Co_{0.03}Mn_{0.6}Zr_{0.01}O₂ | 480 | 230 | 92 | A |
| Example 111 | Li_{1.2}Ni_{0.16}Co_{0.03}Mn_{0.6}Ti_{0.01}O₂ | 480 | 230 | 92 | A |
| Example 112 | Li_{1.2}Ni_{0.16}Co_{0.03}Mn_{0.6}Mg_{0.01}O₂ | 480 | 230 | 92 | A |
| Example 113 | Li_{1.2}Ni_{0.16}Co_{0.03}Mn_{0.6}Nb_{0.01}O₂ | 480 | 230 | 92 | A |
| Example 114 | Li_{1.2}Ni_{0.16}Co_{0.03}Mn_{0.6}Ba_{0.01}O₂ | 480 | 230 | 92 | A |
| Example 115 | Li_{1.2}Ni_{0.16}Co_{0.03}Mn_{0.6}V_{0.01}O₂ | 480 | 230 | 92 | A |
| Example 116 | Li_{1.05}Ni_{0.2}Co_{0.10}Mn_{0.65}O₂ | 480 | 215 | 90 | A |
| Example 117 | Li_{1.3}Ni_{0.1}Co_{0.10}Mn_{0.5}O₂ | 480 | 210 | 90 | A |
| Example 118 | Li_{1.2}Ni_{0.3}Co_{0.10}Mn_{0.4}O₂ | 480 | 220 | 90 | A |
| Example 119 | Li_{1.2}Ni_{0.17}Co_{0.08}Mn_{0.55}O_{1.9}F_{0.15} | 480 | 230 | 93 | A |
| Comparative Example 107 | Li_{1.2}Ni_{0.17}Co_{0.08}Mn_{0.55}O_{1.8}F_{0.2} | 480 | 190 | 95 | F |
| Example 130 | Li_{1.2}Ni_{0.16}Co_{0.03}Mn_{0.6}F_{0.01}O₂ | 480 | 230 | 92 | A |

It has been confirmed that the composition of the active material of each example shown in Tables 6 to 8 is in the range of the following composition formula (I). It has been confirmed that the endothermic peak temperature of the precursor of each example is 550° C. or less. It has been confirmed that the active material formed from the precursor of each example has the space group R(-3)ₘ structure of a rhombohedral system.

Li_{y}NiₐCo_{b}Mn_{c}M_{d}OₓF_{z} (1)

wherein the element M is at least one element selected from the group consisting of Al, Si, Zr, Ti, Fe, Mg, Nb, Ba, and V and 1.95≦(a+b+c+d+y)≦2.1, 1.0≦y≦1.3, 0<a≦0.3, 0≦b≦0.25, 0.3≦c≦0.7, 0≦d≦0.1, 1.9≦(x+z)≦2.0, and 0≦z≦0.15 are satisfied.

Moreover, it has been confirmed that the battery of any example has a discharge capacity of 210 mAh/g or more and a cycle characteristic of 85% or more.

It has been confirmed that the active material formed from the precursor of each comparative example has the space group R(-3)m structure of a rhombohedral system. However, in the comparative examples, it has been confirmed that the endothermic peak temperature of the precursor is more than 550° C. or that the composition of the active material obtained from the precursor was out of the range of the composition formula (1). As a result, it has been confirmed that the battery of any comparative example has a capacity of less than 210 mAh/g or a cycle characteristic of less than 85%.

### DESCRIPTION OF REFERENCE SIGNS

10 POSITIVE ELECTRODE
20 NEGATIVE ELECTRODE
12 POSITIVE ELECTRODE CURRENT COLLECTOR
14 POSITIVE ELECTRODE ACTIVE MATERIAL LAYER
18 SEPARATOR
22 NEGATIVE ELECTRODE CURRENT COLLECTOR
24 NEGATIVE ELECTRODE ACTIVE MATERIAL LAYER
30 POWER GENERATION ELEMENT
50 CASE
60, 62 LEAD
100 LITHIUM ION SECONDARY BATTERY

1. A precursor of an active material, wherein:
the active material obtained by sintering the precursor has a layered structure and is represented by the following composition formula (1); and
a temperature at which the precursor becomes a layered structure compound in the sintering of the precursor in atmospheric air is 450° C. or less:
Li_{y}NiₐCo_{b}Mn_{c}M_{d}OₓF_{z} (1)
wherein the element M is at least one element selected from the group consisting of Al, Si, Zr, Ti, Fe, Mg, Nb, Ba, and V and 1.95≦(a+b+c+d+y)≦2.1, 1.0≦y≦1.3, 0<a≦0.3, 0≦b≦0.25, 0.3≦c≦0.7, 0≦d≦0.1, 1.9≦(x+z)≦2.0, and 0≦z≦0.15 are satisfied.

2. The precursor according to claim 1, wherein a specific surface area thereof is 0.5 to 6.0 m²/g.

3. A manufacturing method for the precursor according to claim 1, comprising a step of adjusting a total value of contents of a sugar and a sugar acid in a raw-material mixture of the precursor to 0.08 to 2.20 mol % relative to a molar number of the active material obtained from the precursor.

4. A manufacturing method for an active material, comprising a step of heating the precursor according to claim 1 at 500 to 1000° C.

5. A lithium ion secondary battery comprising a positive electrode active material layer containing an active material obtained by the manufacturing method for an active material according to claim 4.

6. A precursor of an active material, wherein:
the active material obtained by sintering the precursor has a layered structure and is represented by the following composition formula (1); and
an endothermic peak temperature of the precursor when a temperature of the precursor is increased from 300° C. to 800° C. in differential thermal analysis of the precursor in the atmospheric air is 550° C. or less:
Li_{y}NiₐCo_{b}Mn_{c}M_{d}OₓF_{z} (1)
wherein the element M is at least one element selected from the group consisting of Al, Si, Zr, Ti, Fe, Mg, Nb, Ba, and V and 1.9≦(a+b+c+d+y)≦2.1, 1.0≦y≦1.3, 0<a≦0.3, 0≦b≦0.25, 0.3≦c≦0.7, 0≦d≦0.1, 1.9≦(x+z)≦2.0, and 0≦z≦0.15 are satisfied.

7. The precursor according to claim 6, wherein a specific surface area thereof is 0.5 to 6.0 m²/g.

8. A manufacturing method for an active material, comprising a step of heating the precursor according to claim 6 at 500 to 1000° C.

9. A lithium ion secondary battery comprising a positive electrode active material layer containing an active material obtained by the manufacturing method for an active material according to claim 8.
